(19) United States
(12) Patent Application Publication
(10) Pub. No.: US 2012/0265734 A1
(43) Pub. Date: Oct. 18, 2012

(54) INCREMENTAL COMPILATION OF OBJECT-TO-RELATIONAL MAPPINGS

(75) Inventors: Jorge A. Pérez, Santiago (CL); James F. Terwilliger, Redmond, WA (US); Philip A. Bernstein, Bellevue, WA (US)

(73) Assignee: MICROSOFT CORPORATION, Redmond, WA (US)

(21) Appl. No.: 13/086,414

(22) Filed: Apr. 14, 2011

(51) Int. Cl. G06F 17/30

(52) U.S. Cl. 707/687; 707/756; 707/E17.045

(57) ABSTRACT

Aspects of the subject matter described herein relate to incrementally modifying schemas and mappings. In aspects, an indication of a change to a client schema is received and a compilation directive is received. The compilation directive may indicate how one or more entities or associations in the client schema are to be mapped to the store schema. In response to receiving the indication of the change and the compilation directive, mapping data and storage schema may be incrementally modified with incremental revalidation and incremental updating of query and update views.

### BACKGROUND

Object-relational mapping tools (ORMs) have become a fixture in application programming over relational databases. They provide an application developer the ability to develop against a conceptual model which is generally an entity-relationship model with inheritance. The conceptual model is coupled to a mapping that describes the relationship between the model and a physical database schema. The ORM uses this mapping to translate queries and updates against the model into semantically-equivalent ones of the relational database.

When an application changes, however, the conceptual model for the application may need to change as well. Recompilation and validation in response to a change may be time consuming.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to incrementally modifying schemas and mappings. In aspects, an indication of a change to a client schema is received and a compilation directive is received. The compilation directive may indicate how one or more entities or associations in the client schema are to be mapped to a store schema. In response to receiving the indication of the change and the compilation directive, the mapping data and storage schema may be incrementally modified with incremental revalidation and incremental updating of query and update views.

This Summary is provided to briefly identify some aspects of the subject matter that are further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 illustrates an example of a suitable computing system environment 100 on which aspects of the subject matter described herein may be implemented;

FIG. 2 is a block diagram that generally illustrates generating validated query and update views from a user-defined mapping in accordance with aspects of the subject matter described herein;

FIG. 3 is a block diagram that illustrates an exemplary mechanism for incremental validation and generation of query and update views in accordance with aspects of the subject matter described herein;

FIG. 4 is a block diagram that illustrates fragments of a client and store schema and a mapping between them in accordance with aspects of the subject matter described herein;

FIG. 5 is a block diagram that generally represents an inheritance hierarchy where E has been added as a child of entity type F₂ in accordance with aspects of the subject matter described herein;

FIG. 6 is a block diagram that generally represents an example for adding an entity type in accordance with aspects of the subject matter described herein;

FIG. 7 is a block diagram that generally represents an example where a new entity type is added and mapped as table-per-type in accordance with aspects of the subject matter described herein;

FIG. 8 is a block diagram that generally represents an example where a new entity type is added and mapped as table-per-concrete-type in accordance with aspects of the subject matter described herein;

FIGS. 9 and 10 are block diagrams that generally illustrate refactoring concepts in accordance with aspects of the subject matter described herein;

FIG. 11 is a block diagram representing an exemplary arrangement of components of a system in which aspects of the subject matter described herein may operate; and

FIGS. 12-13 are flow diagrams that generally represent exemplary actions that may occur in accordance with aspects of the subject matter described herein.

### DETAILED DESCRIPTION

### Definitions

As used herein, the term “includes” and its variants are to be read as openended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.” Other definitions, explicit and implicit, may be included below.

### Exemplary Operating Environment

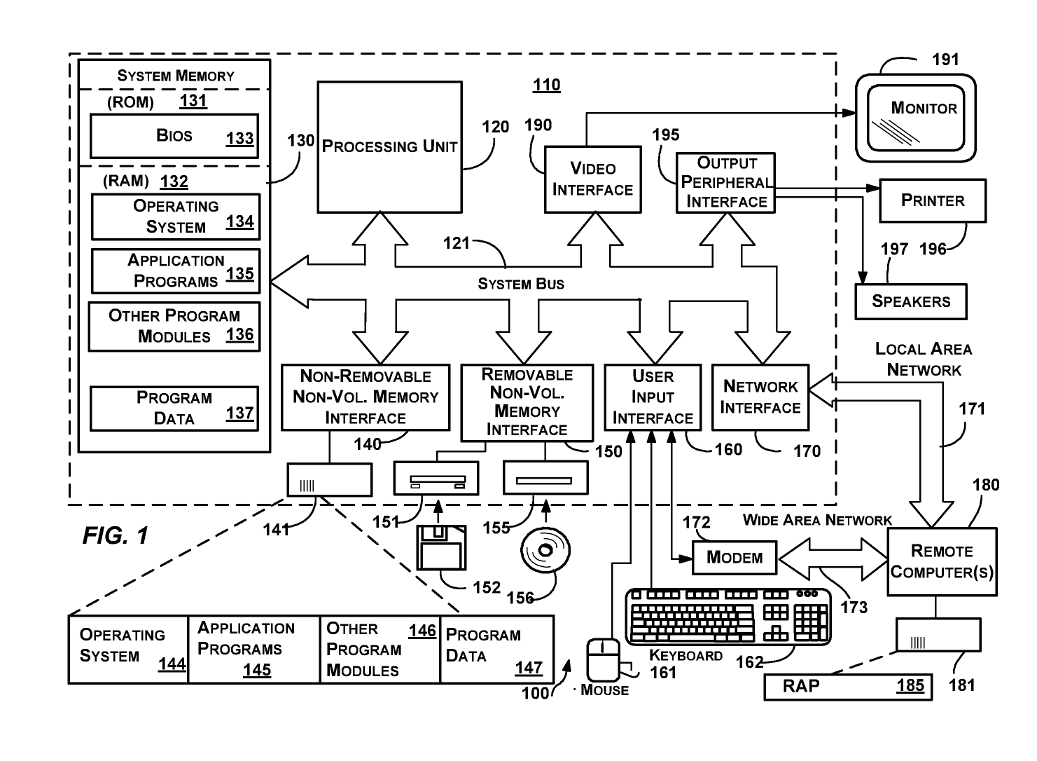

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, solid state devices, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as remote computer(s) 180. Each of the remote computer(s) 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs (RAPs) 185 as residing on memory device 181. It will be appreciated that the network connections shown are exemplary and other means of establishing a communications link between the computers may be used.

### Incremental Activities

As mentioned previously, recompilation and validation in response to a mapping change may be time consuming. In an object-to-relational mapping system (hereinafter “ORM”), a user may define a mapping from an object-oriented view of data that applications manipulate into a relational representation of the data that is stored in a database. The term “object” in ORM is to be read broadly to include both object-to-relational systems and entity-to-relational mapping systems, where an entity differs from an object in that it may not support methods (i.e., user-defined functions). An extended-relational model may include inheritance, which is a feature of object models and entity models. Thus the term ORM also includes extended-relational to relational mapping systems, where the extended relational model includes inheritance. Aspects of the subject matter described herein may be applied to the systems above as well as similar systems.

Herein, the terms “entity” and “association” are sometimes used instead of “object” and “relationship”. Furthermore, the terms “entity set” and “association set” are sometimes used instead of “class” and “relationship set”. In addition, “entity type” and “association type” are sometimes used instead of “object type” and “relationship type”. Even though these alternative terms are often used, they are to be understood to include, in alternative embodiments, the terms for which they are alternatives.

Entity types may be related in a hierarchy. If entity type F is a child of entity type E, then entities of type F are also of type E. Therefore entities of type F have the attributes of E. These attributes are called inherited attributes of F, and F is said to inherit attributes from E.

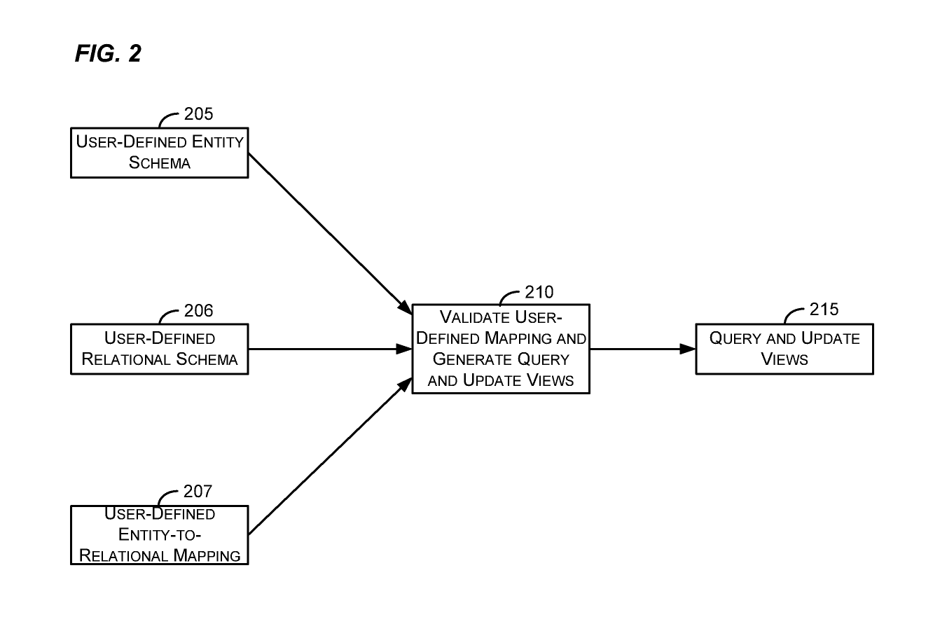

An ORM may compile a user-defined mapping into a representation that is more convenient for the implementation of run-time operations such as queries and updates over the entity sets. For example, FIG. 2 is a block diagram that generally illustrates generating validated query and update views from a user-defined mapping in accordance with aspects of the subject matter described herein.

As illustrated in FIG. 2, a component 210 receives user-defined entity schema data 205, user-defined relational schema data 206, and user-defined entity-to-relational mapping data 207. The component 210 validates the received data and generates query and update views 215 based thereon.

For example, a mapping system may offer a declarative language for defining mappings, which are equations that relate data in an entity set view to data in a relational view. The mapping system may compile equations in this language into query views and update views, where query views enable a framework to execute queries against entity sets and update views enable the framework to execute updates against entity sets.

The compilation process may also validate the mapping to ensure it “roundtrips.” A mapping that “roundtrips” means that given a data set D expressed as an entity set, the following process returns exactly D: (1) store D in an entity set, (2) propagate the updated entity set to the database using the update view, and (3) use the query view to retrieve the entity sets stored in the database. Stated more precisely, it means that the composition of the query view and update view is the identity. This process of ensuring the mapping round-trips may be called “mapping validation.”

A user may decide to change a small part of an object-to-relational mapping. For example, the user might decide to add an entity set or an association set. One exemplary way to handle this is to recompile the entire mapping. Recompilation is certainly correct, but it may be slow. For example, in one implementation, the compilation process may take 5-10 minutes, primarily due to the expense of the validation phase. This compilation time may be annoying to a user, who may have only made a simple change, such as adding an entity set.

An alternative to a complete recompilation is to incrementally modify the query and update views and to define another validation test, all of which leverage the assumption that before the user's change the mapping was correct.

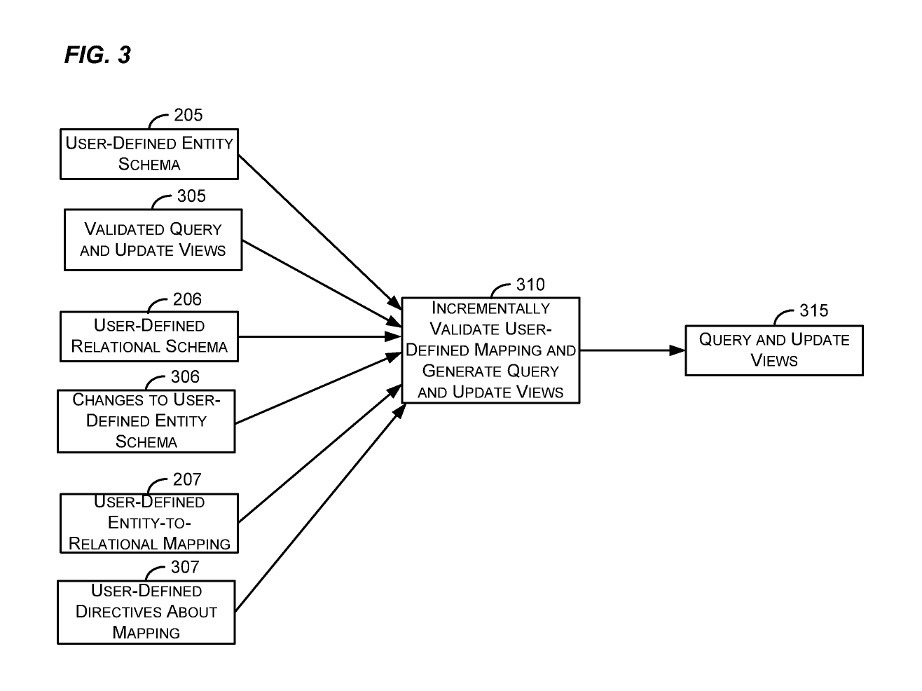

FIG. 3 is a block diagram that illustrates an exemplary mechanism for incremental validation and generation of query and update views in accordance with aspects of the subject matter described herein. As illustrated in FIG. 3, a mapping mechanism 310 receives user-defined entity schema data 205, user-defined relational schema data 206, user-defined entity-to-relational mapping data 207, validated query and update views data 305, changes to user-defined entity schema data 306, and user-defined directives about mapping data 307. The mapping mechanism 310 incrementally validates the received data and generates query and update views 315 based thereon.

User-defined directives about a mapping are sometimes referred to herein as compilation directives. A compilation directive indicates how objects in the client schema are mapped to objects in the store schema. In particular, a compilation directive may indicate that entities are mapped as types using table-per-type (TPT), table-per-concrete-type (TPC), table-per-hierarchy (TPH), and partitioned entity across tables.

To perform the incremental validation and query, it may be assumed that there is a client schema [symbol] , a store schema [symbol] , and a mapping M⊂ [symbol] × [symbol] that is specified by a set Σ of mapping fragments. Furthermore, it may be assumed that:

1. Mapping M roundtrips.

2. For every entity type and association, a corresponding query view has already been computed.

3. For every store relation, a corresponding update view has already been computed.

A mapping fragment may be expressed as a constraint that equates a query over a client schema to a query over a store schema. A query may be a project-select query over a single table or entity type that includes a key. A selection clause may check whether an attribute equals a particular value (e.g., A=5), whether an attribute is or is not null (e.g., A IS NULL or A IS NOT NULL), whether an entity is of a particular type (e.g., E IS OF T), or whether an entity is of exactly one type (e.g., E IS OF (ONLY T)). A selection query may include a combination of selection clauses related by AND or OR.

Let [symbol] ′ represent a new new client schema obtained from [symbol] by an incremental change, and a specification that describes how the new part in [symbol] ′ is to be mapped to [symbol] . Then, the mapping mechanism 310 may adapt mapping M into a new valid mapping M′ and compute query and update views for the new mapping M′.

A view (e.g., for entities, associations, and tables) may be represented in the following form:

Q_{E}|τ_{E}

where Q_{E} is a relational-algebra expression, and τ_{E} is an expression that performs entity (or row) construction. The entity construction τ_{E} may be performed, for example, in Entity SQL as a SELECT VALUE clause. (Entity SQL is an extension of SQL that permits the construction of entity objects and reasoning over entity types.) A complete view of Q_{E}|τ_{E} may take the following form:

SELECT VALUE τ_{E} FROM Q_{E}

To simplify the exposition for views Q_{E}|τ_{E}, the result of Q_{E} may contain all the attribute names of E consistently named.

For example, for an entity type E with attributes Id and A that has a derived type F with attributes Id, A and B, and two tables, R₁(X, Y) and R₂(U,V), the following is an example of a view for entity type E (where π is a realtional projection operator and [symbol] is a relational left outerjoin):

Q_{E}:π_{X AS Id,Y AS A}(R₁) [symbol] Σ_{U AS Id,V AS B,ƒ←true}(R₂)

τ_{E}:if (ƒ=true) then F(Id,A,B) else E(Id,A)

In queries mentioned herein, an extended relational projection operator π may contain constants in the projection lists assigned to specific attribute names. For example the expression π_{U,ƒ←true}(R) is equivalent to π_{U,ƒ}(R×F) where F is a relation with a single attribute ƒ and a single tuple with the value true. The keyword AS may also be used in the projection list to rename attributes.

The complete query Q_{E}|τ_{E} may be expressed in Microsoft's Entity SQL as follows:

SELECT VALUE

IF (T.f) THEN F(T.Id, T.A, T.B)
ELSE E(T.Id, T.A)

FROM

| | |
|---|---|
| ( | ( SELECT R1.X AS Id, R1.Y AS A |

FROM R1 ) AS T1

LEFT OUTER JOIN
( SELECT R2.U AS Id, R2.V AS B, true AS f

FROM R2 ) AS T2

ON T1.Id = T2.Id

) AS T

Unless indicated otherwise, relational expressions are expressed herein as natural joins, natural outer joins, etc. To translate a relational expression into Entity SQL, aliases may be used for intermediate results and to specify the attributes over which to perform joins and outer joins.

A query may be constructed as a union of two previously constructed queries. To do this, the results of the queries that are to be unioned may be converted into schema-compatible tables. For example, the following two queries are not schema-compatible and do not even have the same number of attributes:

Q_{F}:π_{Id,A,B,C,t}_{₁}_{←true}(R)

Q_{G}:π_{Id,C,D,t}_{₂}_{←true}(S)

Given two lists of attributes α₁ and α₂, their union may be constructed as a new list denoted by (α₁ pad α₂) as follows:
for every attribute name Aεα₁, the list (α₁ pad α₂) contains A.
for every attribute name Aεα₂\α₁, the list (α₁ pad α₂) contains A←false if A is a Boolean attribute, and contains A←null otherwise.

For example, for the lists α₁=(Id, A, B, C, t₁←true) and α₂=(Id, C, D, t₂←true), their union is as follows:

(α₁ pad α₂)=(Id,A,B,C,t₁,D←null,t₂←false)

(α₂ pad α₁)=(Id,C,D,t₂,A←null,B←null,t₁←false)

Thus, given two queries of Q₁ and Q₂ that have as output lists of attribute names α₁ and α₂ respectively, a union may be performed by the expression:

π_{α}_{₁}∪α_{₂}(π_{α}_{₁} _{pad α}_{₂}(Q₁))∪π_{α}_{₁}_{∪α}_{₂}(π_{α}_{₂} _{pad α}_{₁}(Q₂)).

The outermost projections over attributes α₁∪α₂ ensure that the order of the attributes in both sides of the union is the same. These projections may be omitted if both projections over (α₁ pad α₂) and (α₂ pad α₁) have their attribute names in the same order. For example, for queries Q_{F} and Q_{G} above, a union may be taken using the following expression:

π_{Id,A,B,C,D←null,t}_{₁}_{,t}_{₂}_{←false}(π_{Id,A,B,C,t}_{ᵢ}_{←true}(R))∪π_{Id,A←null,B←null,C,D,t}_{₁}_{←false,t}_{₂}(π_{Id,C,D,t}_{₂}_{←true}(S)). (1)

This expression may be simplified to obtain:

π_{Id,A,B,C,D←null,t}_{₁}_{←true,t}_{₂}_{←false}(R)∪π_{Id,A,←null,B←null,C,D,t}_{₁}_{←false,t}_{₂}_{←true}(S) (2)

To simplify the exposition, the symbol \hat{∪} may be used to denote the above union. With this terminology, the expression:

π_{Id,A,B,C,t}_{ᵢ}_{←true}(R)\hat{∪}π_{Id,C,D,t}_{₂}_{←true}(S)

is equivalent to expression (2).

### Table-Per-Type/Table-Per-Concrete-Type

A method for incremental view computation for mapping entity types such as table-per-type (TPT) and table-per-concrete-type TPC is described below. The example below relates to a case where a new entity type E is added as a leaf in a (possibly empty) hierarchy, but the teachings described herein may also be applied in other situations. For the example, it may be assumed that PK_{E} is the set of primary key attributes of E, and that E is added to a hierarchy inside an entity set ε. Furthermore, it may be assumed, for this example, that ε is fixed.

When the TPT strategy is followed, the primary key and the non-inherited attributes of E are mapped into a table, for example, T. Then to construct entities of type E, data from T may be joined with data from other tables. On the other hand, when one follows TPC, all the attributes of E are mapped into a table, say R. Thus, in this case, to construct entities of type E, only data from R is needed.

Mapping fragments may be defined to use more general forms to map entities. Below, a generalization of TPT and TPC is used in which an arbitrary set of the attributes of E (along with the primary key) is mapped to some table. The primitive for adding entities is the following:

AddEntity(E,E′,α,P,T,ƒ),

where:

1. E is the new entity type to be added.

2. E′ is the parent of E in the hierarchy (NIL if E is the root of a new hierarchy).

3. α is a subset of the attributes of E, denoted att(E), that contains PK_{E}.

4. P is an ancestor of E in the hierarchy such that α∪att(P)=att(E). P can be specified as NIL in which case it holds that α=att(E). P may not be an abstract entity type.

5. T is a table in the store schema that is not mentioned in any mapping fragment.

6. ƒ:α→att(T) is a 1-1 function that maps the primary key of E to the primary key of T. Unless the context indicates otherwise, functions mentioned herein are total functions. The function ƒ is such that for every attribute AεΔ it holds that dom(A)⊂dom(ƒ(A)). Moreover, all attributes in att(T)\ƒ(α) are nullable.

The semantics of the addition of a new entity by using AddEntity(E, E′, α, P, T, ƒ) is given by the following mapping fragment, where the Entity SQL clause “IS OF E” is true for entities of type E:

π_{α}(σ_{IS OF E}(ε))=π_{ƒ(α)}(T) (3)

The above mapping fragment specifies how attributes a are mapped into table T. To reconstruct E-entities, the missing attributes may be retrieved from some other tables in the store schema. The reference to the ancestor P in AddEntity is used to deal with this problem. That reference states that all the attributes of E that are not mapped to T are to be mapped as attributes of P.

Both TPT and TPC may be obtained from the above primitive. For instance, to map a new entity E by using the TPC strategy into a table T, the following may be used:

AddEntity(E,E′,att(E),NIL,T,ƒ)

That is, all E attributes (inherited and non-inherited) are mapped to table T. The NIL reference indicates that there is no need to obtain information from any other table to reconstruct entities of type E. On the other hand, to map the new entity E by using the TPT strategy the following may be used:

AddEntity(E,E′,(att(E′)\att(E))∪PK_{E},E′,T,ƒ)

That is, only the non-inherited attributes of E plus its primary key are mapped to table T. The reference to entity type E′ states that the remaining attributes of entities of type E are mapped in the same way as for E′ (which is the parent of E in the hierarchy).

Below is presented the formal procedures needed to adapt (and validate) a mapping after the addition of a new entity type, and to create query and update views incrementally.

Adapting the Mapping Fragments.

Assume that a new entity has been added by using AddEntity(E, E′, α, P, T, ƒ), as explained above. Let Σ⁻ be the set of mapping fragments before the addition of the new entity, and let φ_{E} denote the mapping fragment

φ_{E}: π_{α}(σ_{IS OF E}(ε))=π_{ƒ(α)}(T).

The set Σ⁻ does not specify a valid mapping for the new client schema since mapping fragments in Σ⁻ do not even mention the new entity type E. Moreover, if φ_{E} is added to the set Σ⁻, the resulting mapping may be non valid. Thus changes are made to Σ⁻before adding φ_{E} in order to ensure that the new mapping roundtrips. An idea behind the process is to construct a set Σ* that is semantically equivalent to Σ⁻ when considering the old schema, but such that the set Σ*∪{φ_{E}} specifies a valid mapping for the new schema.

The formal process to adapt the mapping fragments after using AddEntity(E, E′, α, P, T, ƒ) is shown in Algorithm 1 below.

| Algorithm 1: Adapt Mapping Fragments for AddEntity(E, E′, α, P, T, f) | |
|---|---|
| Let φ_{E} be the mapping fragment: | |
| π_{α}(σ_{IS OF E}(ε)) = π_{f(α)}(T). | |
| 0. Check validity of associated foreign keys: | |
| (a) If there exists an entity type F that is a proper ancestor of E and a proper | |
| descendant of P, and an association [symbol] that has F as endpoint, then do the following. | |
| It is assumed that each association is mapped to a single table (this is a restriction of | |
| the mapping language). Thus, assume that [symbol] is mapped to table R and that the key | |
| attributes of F, say PK_{F}, are mapped to attributes β in R. There are two cases to | |
| check. First, check the containment π_{F.PK}_{_{F}} _{AS β} ( [symbol] ) [symbol] π_{β} (Q_{R}) , using the update view | |
| Q_{R} generated in the following section. This check tests whether associations of | |
| entities of the new entity type E (that derives from F) may be stored in the same table | |
| R. If the containment fails, abort; the mapping fragments cannot be adapted. Now, if there | |
| is a foreign key of the form β′ → γ where β ∩ β′ ≠ Ø from R to some table S, | |
| then check that the foreign key is not violated by testing the containment | |
| π_{β′} _{AS γ} (Q_{R}) [symbol] π_{γ}(Q_{S}) where Q_{S} is the update view for S, generated in the following | |
| section. If the containment fails, abort; the mapping fragments cannot be adapted. | |
| (b) If T has a foreign key constraint β → β′ to a table T′ with β ∩ f(α) ≠ | |
| Ø, then check that the addition of the new entity does not violate that constraint. This | |
| can be done by checking the query containment π_{β}(Q_{T}) [symbol] π_{β′}(Q_{T′}) using the update | |
| views Q_{T} and Q_{T′} generated in the following section. If the containment fails, abort; | |
| the mapping fragments cannot be adapted. | |
| 1. For every mapping fragment ψ in Σ⁻ do the following: | |
| (a) Replace every occurrence of an expression IS OF (ONLY P) in ψ, by the | |
| expression: | |
| IS OF (ONLY P) [symbol] IS OF E | (5) |
| (b) For every entity type F that is a proper ancestor of E and a proper descendant | |
| of P, if the expression IS OF F occurs in ψ, then replace it by | |
| ${}_{{{F}^{′} descendant of F}_{{F}^{′} proper ancestor of E}} ( IS OF ( ONLY {F}^{′} ) {}_{{{F}^{″ child of {F}^{′}}}_{{F}^{″} not ancestor of E}} IS OF {F}^{″} ) \qquad$ | (6) |
| (If P is NIL, then its set of descendants are to be considered as the whole | |
| hierarchy.) | |
| 2. Let Σ* be the resulting set of mapping fragments. The new set of mapping | |
| fragments is Σ* ∪ {φ_{E}}. | |

For some terminology, an ancestor of an entity E is an entity E′ that lies on the path from E to the root of the entity set. Every entity is an ancestor of itself. A proper ancestor of an entity is an ancestor that is not the entity itself. Likewise, a descendant of an entity includes all nodes of a tree of which the entity is an ancestor, while a proper descendant of an entity is a descendant of the entity that is not the entity itself.

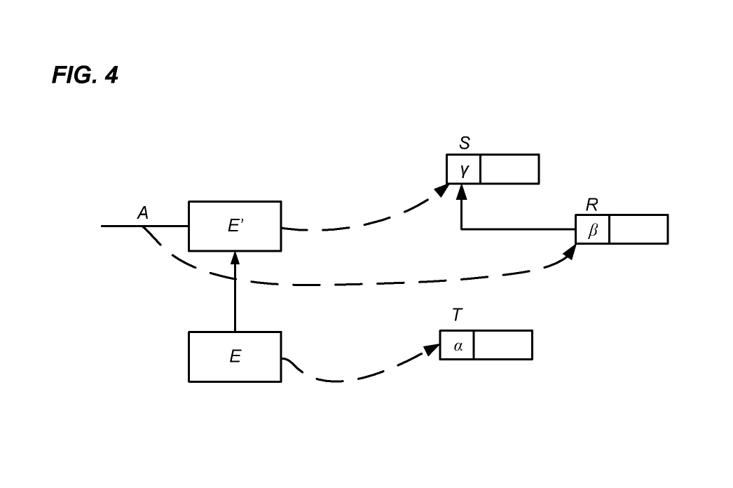

Point 0 of the algorithm is used for validating the mapping. The algorithm checks that the addition of new entities of type E does not violate foreign key constraints in the store. An example of failure of this check is shown in FIG. 4.

FIG. 4 is a block diagram that illustrates fragments of a client and store schema and a mapping between them in accordance with aspects of the subject matter described herein. Assume first that only entity type E′ and association [symbol] (shown as A) are mapped. In FIG. 4, entity type E′ is mapped to table S and association [symbol] is mapped to table R. Assume that the key attributes of E′ are mapped to attributes γ in S and that the attributes of [symbol] that correspond to keys of the E′ endpoint of the association are mapped to attributes β in R. The table R has a foreign key constraint β→γ to table S. In the absence of entity type E in the mapping, the foreign key constraint β→γ is satisfied. This is, because the set of possible values of attribute β in table R comes from association [symbol] , they are key values of entities of type E′ (which are all mapped to attribute γ in S).

Now consider entity type E which inherits from E′ and is mapped as TPC to table T. Now association [symbol] may be relating entities of the new type E and storing the corresponding key values in table R. Notice that since E is mapped as TPC all the values (including key attributes) for entities of type E are stored in table T. Thus, table S does not contain the key values of entities of type E. This implies that the foreign key constraint β→γ will be violated whenever an entity of type E participates in association [symbol] . Point 0 of Algorithm 1 uses the update views described below to skip the adaptation of mappings whenever a foreign key constraint can be violated when storing data of the new added entity type, as in the case explained above.

Point 1 adapts the mapping for the addition of the new entity. The semantics of the primitive AddEntity(E, E′, α, P, T, ƒ) states that a attributes of entity type E are to be mapped to table T and all the remaining attributes are to be mapped as for entities of type P. Thus, if some mapping fragment includes a condition of the form IS OF (ONLY P) it is to be replaced by IS OF (ONLY P) [symbol] IS OF E. These changes are performed in Point (1a) of Algorithm 1.

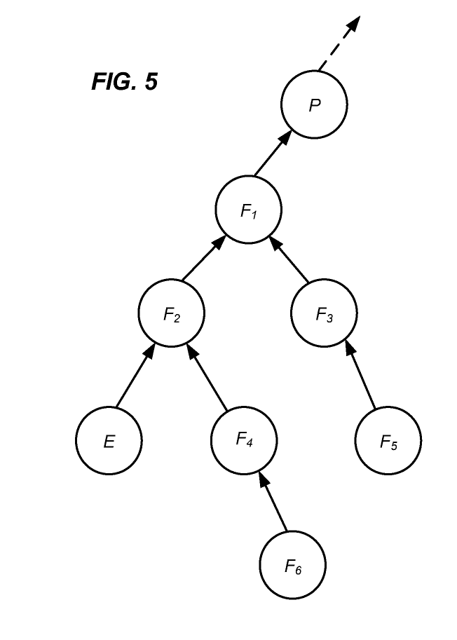

Point (1b) makes a complementary adaptation regarding entity types inbetween E and P. For example, assume that a mapping fragment includes a condition of the form IS OF F where F is a proper ancestor of E and a proper descendant of P in the hierarchy. Notice that a condition of the form IS OF F will be satisfied by entities of type E (since E is a descendant of F in the hierarchy). Nevertheless, all the attributes of E are mapped either to table T or to the tables to which attributes of P are mapped. Thus, the expression IS OF F is replaced by an expression that rules out entities of type E. Point (2b) does these changes. As an example of a generated expression, consider the hierarchy of FIG. 5.

FIG. 5 is a block diagram that generally represents an inheritance hierarchy where E has been added as a child of entity type F₂ in accordance with aspects of the subject matter described herein. If some mapping fragment mentions expression IS OF F₁, then the expression may be replaced by:

(IS OF(ONLY F₁) [symbol] IS OF F₃) [symbol] (IS OF(ONLY F₂) [symbol] IS OF F₄) (4)

The set of mapping fragments Σ* generated by Algorithm 1 is semantically equivalent to Σ⁻ when considering client states that do not have entities of type E (that is, when the client-side constraint σ_{IS OF E} (ε)=Ø is imposed). If entity type E is empty then expression (5) is equivalent to IS OF (ONLY P) and expression (6) is equivalent to IS OF F. In particular, considering the hierarchy of FIG. 5, the expression IS OF F₁ is equivalent to the expression (4) when considering entity type E is empty.

Furthermore, Algorithm 1 makes changes to the previous mapping fragments. Depending on the application scenario, these changes may be undesirable. If that is the case, the adaptation procedure may be changed to a pure validation procedure that tests whether the new entity may be safely added without changing any previous mapping fragment.

Also, if in Point 0 Check b of Algorithm 1, β is not part of the primary key of T, then the algorithm may safely abort without checking the query containment. One reason for this is that mapping fragments only map keys in the client with keys in the store. Thus, since β′ is the primary key of table T′, either β′ is mapped to a key of some entity set or is not mapped at all. In the latter case, T′ is not mentioned in any mapping fragment, and the query containment fails since Q_{T′} returns an empty result. In the former case, the containment implies that values of some non-key attributes of E entities will always be keys of entities of some entity type, which fails in general.

Incrementally Computing Views.

Given an entity type F in [symbol] , Q_{F}⁻|τ_{F}⁻ denotes the query view for type F before the addition of the new entity type. Similarly, given a table R in [symbol] , Q_{R}⁻|τ_{R}⁻ denotes the update view for table R before the addition of the new entity type. Assume that a new entity E is added to the client schema by using:

AddEntity(E,E′,α,P,T,ƒ),

and that mapping fragments have been adapted as explained above. Algorithm 2 shows a procedure to compute the new query views for the new entity type and to incrementally recompute query views for the previous entity types as follows:

Algorithm 2: Reconstruct Query Views for AddEntity(E, E′, α, P, T, f)

```
1. The query view for E is constructed as follows. If P = NIL, then
    Q_{E}: π_{f (α) AS α} (T)
    τ_{E}: E(att(E))
If P ≠ NIL, then the query view for E is:
    Q_{E}: Q_{P}⁻ [symbol]  π_{f (α) AS α} (T)
    τ_{E}: E(att(E))
2. For every entity type F that is a proper ancestor of E and a proper
descendant of P, the query views are reconstructed as follows. First
consider the query Q_{E}* which is defined as
${Q}_{E}^{*} = \{ \begin{matrix}{π}_{f ( α ) AS α , {t}_{E} ← true} ( T ) & if P = NIL \\ {Q}_{P}^{-} {π}_{f ( α ) AS α , {t}_{E} ← true} ( T ) & if P \neq NIL\end{matrix}$
with t_{E} a fresh attribute name, not previously mentioned in query views.
Then the query view for entity type F is:
    Q_{F}: Q_{F}⁻ \hat{∪} Q_{E}*
    τ_{F}: if (t_{E} = true) then τ_{E} else τ_{F}⁻.
3. For every entity type F that is an ancestor of P, the query views are
reconstructed as follows:
    Q_{F}: Q_{F}⁻ [symbol]  π_{f (α) AS α,t}_{_{E}}_{←true}(T)
    τ_{F}: if (t_{E} = true) then τ_{E} else τ_{F}⁻
where t_{E} is a fresh attribute name, not previously mentioned in query views.
4. For all other entity types (not ancestors of E), and for all the associa-
tion sets, query views are not changed.
```

In Algorithm 2 the expression ƒ(α) AS α denotes a renaming of attributes. For example, if α is the list Id, A, and ƒ(Id)=X and ƒ(A)=Y, then ƒ(α) AS α denotes the list X AS Id, Y AS A.

One assumption mentioned previously is that the result of query view Q_{P}⁻ contains all P attributes consistently named. Since att(E)=att(P)∪α, the query Q_{E} in Step 1 of Algorithm 2 contains all the attributes in att(E). Also in Algorithm 2, the new attribute t_{E} attached to query views in Steps 2 and 3 is used to test provenance of tuples.

Furthermore, there is not an assumption that att(P)∩α=PK_{E}. That is, att(P) and α may share more attributes than just the primary key of E. This may be used to rewrite some queries in order to obtain queries that are more efficient to execute. In particular, every usage of α in Algorithm 2 may be replaced by the set of attributes α′=(α\att(P))∪PK_{E}. Then for example, the query view for E created in Step 1 of Algorithm 2 for the case of P≠NIL may be rewritten as:

Q_{P}⁻ [symbol] π_{ƒ(α′) AS α′}(T).

Algorithm 3 (shown below) recomputes update views. Algorithm 3 uses a strategy similar to the strategy used for adapting the mapping fragments.

Algorithm 3: Reconstruct Update Views for AddEntity(E, E′, α, P, T, f)

```
1. The update view for T is
    Q_{T}: π_{(α} _{AS f(α))pad att(T)} (σ _{IS OF E}(ε))
    τ_{T}: T(att(T))
2. For every update view Q_{R}⁻ , construct Q_{R} from Q_{R}⁻ as follows:
  (a) Replace every occurrence of an expression IS OF (ONLY P) in Q_{R}⁻,
by the expression
IS OF (ONLY P) [symbol]     IS OF E
  (b) For every entity type F that is a proper ancestor of E and a proper
descendant of P, if the expression IS OF F occurs in Q_{R}⁻, then replace it by
${{}_{{F}^{′} descendant of F}}_{{F}^{′} proper ancestor of E} ( IS OF ( ONLY {F}^{′} ) {{}_{{F}^{′′} child of {F}^{′}}}_{{F}^{′′ } not ancestor of E} IS OF {F}^{′′} )$
```

### Example of Adding Entity Types

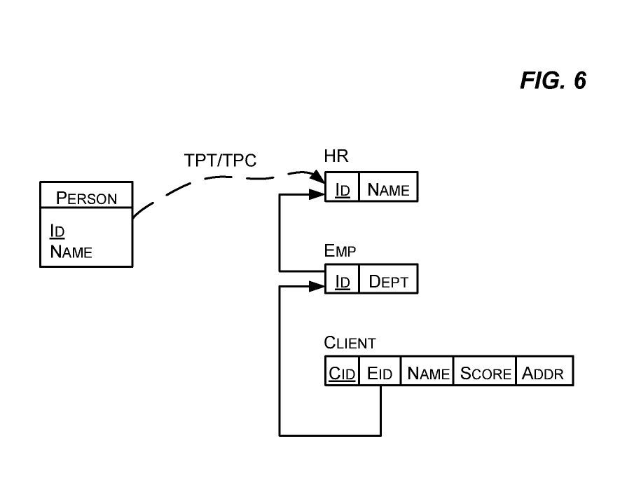

FIG. 6 is a block diagram that generally represents an example for adding an entity type in accordance with aspects of the subject matter described herein. Consider a store schema with relations:

HR(Id,Name),Emp(Id,Dept),Client(Cid,Eid,Name,Score,Addr),

and the following foreign key constraints: Emp. Id→HR. Id, Client. Eid→Emp. Id as illustrated in FIG. 6. Consider first an empty client schema and an empty mapping M₀, given by the set Σ₀=Ø. Those skilled in the art will recognize that M₀ is valid. Now a new client schema and the corresponding mapping fragments may be incrementally constructed using the procedures previously described. As components may be added step by step, incremental versions may be denoted of every view by using super-indexes. For example, for an entity type E, Q_{E}¹ denotes the query view after the first incremental addition, Q_{E}² denotes the new version of the query view after the second incremental addition, and so forth.

Step 1: adding an entity type: Person. As a first step, an entity type Person (Id, Name) is added as the root of a hierarchy inside an entity set Persons, and this entity type is mapped to table HR as shown in FIG. 6. To do this, the following primitive is used:

AddEntity(Person,NIL,(Id,Name),NIL,HR,ƒ_{Person}),

where ƒ_{Person} is such that ƒ_{Person}(Id)=Id and ƒ_{Person}(Name)=Name. Algorithm 1 is then followed. No check of validity is necessary in this case since there is no foreign key from HR to any other table and there is no ancestor of Person in the hierarchy. Also, since Σ₀=Ø, there is no previous mapping to adapt. Thus, the algorithm adds the mapping fragment φ₁ given by:

π_{Id,Name}(σ_{IS OF Person}(Persons))=π_{Id,Name}(HR),

and considers the new mapping M₁ specified by the set Σ₁={φ₁}.

Next query and update views are computed for M₁. Following Algorithm 2 (Step 1) the following query view is obtained:

Q_{Person}¹:π_{Id,Name}(HR)

τ_{Person}¹:Person(Id,Name).

Following Algorithm 3 (Step 1), the following update view is obtained:

Q_{HR}¹:π_{Id,Name}(σ_{IS OF Person}(Persons))

τ_{HR}¹:HR(Id,Name).

No renaming or padding is needed given that the name of attributes in Person and HR match.

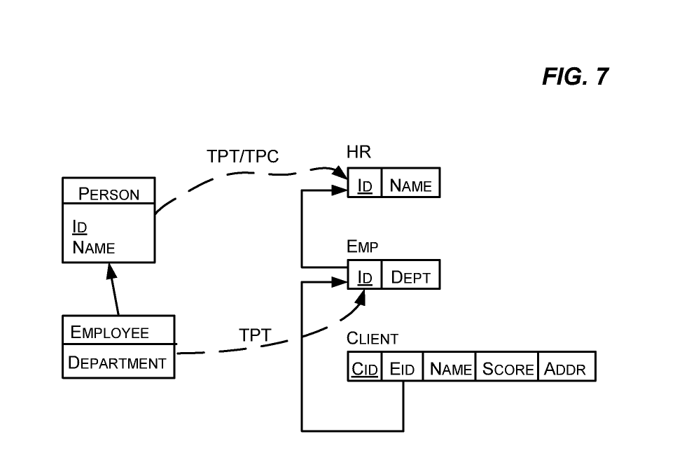

Step 2: adding a derived entity type Employee as TPT. To do this, an entity type Employee (Id, Name, Department) is added that derives from Person. This new entity type is mapped as TPT to table Emp, as shown in FIG. 7, where a new Employee entity type is added and mapped as TPT. To do this, the following primitive is used:

AddEntity(Employee,Person,(Id,Department),Person,Emp,ƒ_{Employee}),

where ƒ_{Employee} is such that ƒ_{Employee}(Id)=Id and ƒ_{Employee}(Department)=Dept.

To adapt the mapping, Algorithm 1 is followed. At Step 0, a check is performed to determine that the foreign key constraint Emp. Id→HR. Id is not violated. For this check, an update view for Emp is constructed. Then the foreign key constraint is checked later. Since φ₁ does not mention any condition of the form IS OF (ONLY Person), there is no mapping fragment to adapt. Thus, the algorithm considers the mapping M₂ specified by the set Σ₂={φ₁, φ₂} where φ₂ is the mapping fragment:

π_{Id,Department}(σ_{IS OF Employee}(Persons))=π_{Id,Dept}(Emp)

Next, the query and update views are computed for the new entity type, and the previous queries are incrementally recomputed. Algorithm 2 may be followed first to construct query views. The entity type Person is playing the role of P in the algorithm. Thus, to construct the query view for entity Employee, the previously computed query view Q_{Person}¹ (see Step 1 of the algorithm) is used as follows:

Q_{Employee}²:Q_{Person}¹ [symbol] π_{Id,Dept AS Department}(Emp)=

π_{Id,Name}(HR) [symbol] π_{Id,Dept AS Department}(Emp)

τ_{Employee}:Employee(Id,Name,Department)

Now, since Person is playing the role of P, to reconstruct query view for Person, Step 3 of Algorithm 2 is followed. Thus, the new query view for Person is obtained by considering Q_{Person}¹ as follows:

Q_{Person}²:Q_{Person}¹ [symbol] π_{Id,Dept AS Department,t}_{_{Employee}}_{←true}(Emp)=

π_{Id,Name}(HR) [symbol] π_{Id, Dept AS Department,t}_{_{Employee}}_{←true}(Emp)

τ_{Person}²:if (t_{Employee}) then τ_{Employee}² else τ_{Person}¹=

if (t_{Employee}) then Employee(Id, Name, Department) else Person(Id, Name)

To construct update views Algorithm 3 is followed. In Step 1, the algorithm constructs the update view for table Emp as follows:

Q_{Emp}²:π_{Id,Department AS Dept}(σ_{IS OF Employee}(Persons))

τ_{Emp}²:Emp(Id,Dept).

The only previously computed update view is the view for table HR. Since this view does not mention an expression of the form IS OF (ONLY Person), it is not changed in Step 2 of the algorithm and the following results:

Q_{HR}²:Q_{HR}¹=π_{Id,Name}(σ_{IS OF Person}(Persons))

τ_{HR}²:τ_{HR}¹=HR(Id,Name).

Now that the update views have been recomputed, Step 0 (part b) of Algorithm 1 may be performed to test whether the foreign key constraint Emp. Id→HR. Id is violated. This step tests the containment:

π_{Id}(Q_{Emp}²)⊂π_{Id}(Q_{HR}²).

By unfolding the update views in the previous expression, the check

π_{Id}(σ_{IS OF Employee}(Persons))⊂π_{Id}(σ_{IS OF Person}(Persons)).

holds since Employee inherits from Person. Thus, the mapping is valid and the algorithm has been followed to incrementally recompute all the query and update views.

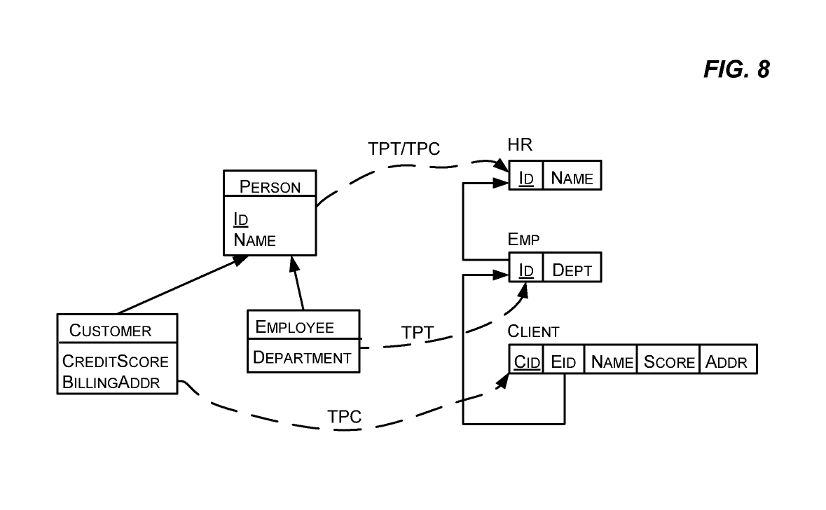

Step 3: adding a derived entity type Customer as TPC. Now, an entity type Customer(Id, Name, CreditScore, BillingAddr) is added that derives from Person. This new entity type is then added as TPC to table Client as shown in FIG. 8. To do this, the following primitive is used:

AddEntity(Customer,Person,(Id,Name,CreditScore,BillingAddr), NIL,Client,ƒ_{Customer}),

where ƒ_{Customer} is such that ƒ_{Customer}(Id)=Cid, ƒ_{Customer}(Name)=Name, ƒ_{Customer}(CreditScore)=Score, and ƒ_{Customer}(BillingAddr)=Addr.

Algorithm 1 is followed to first adapt the mapping fragments. In Step 0, there is no need to check validity with respect to the foreign key constraint Client. Eid→Emp. Id since none of the attributes of the new entity type is mapped to attribute Eid in table Client. Furthermore, NIL is playing the role of P in Algorithm 1. Thus, Person is a proper ancestor of Customer and a proper descendant of P (NIL in this case). Then, since mapping fragment φ₁ mentions the expression IS OF Person, it is replaced by:

IS OF(ONLY Person) [symbol] IS OF Employee

(see formula (6) in Step 1b of Algorithm 1). Thus, the output of the algorithm is the set of mapping fragments Σ₃={φ₁, φ₂, φ₃}, where

φ_{1′}:π_{Id,Name}(σ_{IS OF(ONLY Person)} [symbol] _{IS OF Employee}(Persons))=π_{Id,Name}(HR)

φ₂: π_{Id,Department}(σ_{IS OF Employee}(Persons))=π_{Id,Dept}(Emp)

φ₃: π_{Id,Name,CreditScore,BillingAddr}(σ_{IS OF Customer}(Persons))=π_{Cid,Name,Score,Addr}(Client)

Next, the query and update views for the new entity are computed and the previous queries recomputed. Following Step 1 of Algorithm 2, since P=NIL, for entity Customer the query view is constructed by considering only the table Client:

Q_{Customer}³:π_{Cid AS Id,Name,Score AS CreditScore,Addr AS BillingAddr}(Client)

τ_{Customer}³:Customer(Id,Name,CreditScore,BillingAddr)

Person is a proper ancestor of Customer and a proper descendant of P=NIL. Thus, in Step 2 of Algorithm 2, to recompute the query view for Person, Q₂^{Person} and (Q_{Customer}³)* may be used as follows:

Q_{Person}³:Q_{Person}²

\hat{∪}π_{Cid AS Id,Name,Score AS CreditScore,Addr AS BillingAddr,t}_{_{Customer}}_{←true}(Client)=

(π_{Id,Name}(HR) [symbol] π_{Id,Dept AS Department,t}_{_{Employee}}_{←true}(Emp))\hat{∪}

(π_{Cid AS Id,Name,Score AS CreditScore,Addr AS BillingAddr,t}_{_{Customer}}_{←true}(Client))

τ_{Person}³:if (t_{Customer}) then τ_{Customer}³ else τ_{Person}²=

if (t_{Customer}) then Customer(Id,Name,CreditScore,BillingAddr)

else{if (t_{Employee}) then Employee(Id,Name,Department)

else Person(Id,Name)}

For the case of Employee the query view does not change, giving:

Q_{Employee}³:Q_{Employee}²=π_{Id,Name}(HR) [symbol] _{Id,Dept AS Department}(Emp)

τ_{Employee}³:τ_{Employee}²=Employee(Id,Name,Department)

To compute update views, Algorithm 3 is followed. In Step 1, the update view for table Client is generated as follows:

Q_{Client}³:π_{Id AS Cid,Eid←null,Name,CreditScore AS Score,BillingAddr AS Addr}(σ_{IS OF Customer}(Persons))

τ_{Client}³:Client(Cid,Eid,Name,Score,Addr).

Eid←null appears in the projection list because of the padding operation that is needed to construct the update view (see Step 1 in Algorithm 3). As for the adaptation of the mapping fragments, since the update view Q_{HR}² mentions the expression IS OF Person, in Step 2 of the algorithm the last expression is replaced by:

IS OF(ONLY Person) [symbol] IS OF Employee.

Thus, the new update view for HR is the following:

Q_{HR}³:π_{Id,Name}(σ_{ISOF(ONLY Person)} [symbol] _{IS OF Employee}(Persons))

τ_{HR}³:HR(Id,Name).

For the case of Emp the update view does not change and is as follows:

Q_{Emp}³:Q_{Emp}²=π_{Id,Department AS Dept}(σ_{IS OF Employee}(Persons))

τ_{Emp}³:τ_{Emp}²=Emp(Id,Dept).

This completes the example for now. Below, a solution is described to add associations and complete the example by adding an association between entity types Customer and Employee.

### Adding Associations

Two cases relate to adding associations:

1. A new association set is mapped to a join table T where the keys of both endpoints of the association are mapped to the primary key of T. Table T is not previously mentioned in any mapping fragment (and thus, it is not mentioned in any update view).

2. A new association set is mapped to table T, the key of one of the endpoints of the association is mapped to the primary key of T, and the key of the other endpoint is mapped to a different set of attributes in T. Table T is already mentioned in a mapping fragment and thus has an associated update view.

Associations Mapped to Join Tables.

The following primitive may be used to add associations:

AddAssocJT( [symbol] ,E₁,E₂,mult,T,ƒ)

where:
1. [symbol] is the name of the new association set.
2. E₁ and E₂ are the endpoints of the association.
3. mult is an expression that denotes the multiplicity of the association.
4. T is a table not previously mentioned in mapping fragments.
5. ƒ is a 1-1 function that satisfies the following. Assume that a is the set of primary key attributes of E₁ and β is the set of primary key attributes of E₂. Then either ƒ(E₁·α) is the primary key of T, or ƒ(E₁·α)∪ƒ(E₂·β) is the primary key of T, and both ƒ(E₁·α) and ƒ(E₂·β) are non-nullable sets of attributes in T. Moreover, if T has foreign key constraints, then these foreign keys are of the form ƒ(E₁·α)→α′ or of the form ƒ(E₂·β)→β′.

The semantics of the addition of the new association using the above primitive is given by the following mapping fragment:

π_{E}_{₁}_{·α,E}_{₂}_{·β}( [symbol] )=π_{ƒ(E}_{₁}_{·α),ƒ(E}_{₂}_{·β)}(T)

Adapting the Mapping Fragments. Let Σ⁻ be the set of mapping fragments before the addition of the new association, and let [symbol] denote the mapping fragment

π_{E}_{₁}_{·α,E}_{₂}_{·β}( [symbol] )=π_{ƒ(E}_{₁}_{·α),ƒ(E}_{₂}_{·β)}(T)

In this case, there is no need to adapt the previous set of mapping fragments. Rather, it is sufficient to check the validity of the mapping specified by Σ=Σ⁻∪{ [symbol] }. To do this, Algorithm 4 checks that if T has associated foreign key constraints, these constraints are not violated.

Algorithm 4: Check Validity of Mapping Fragments for
AddAssocJT( [symbol] ,E₁,E₂,mult,T,f)

```
    1. If f(E₂·β) is not part of the primary key of T, then check that the
multiplicity of the E₂ end is not *. If the check fails then abort.
    2. If T has a foreign key of the form f(E₁·α) → α′ to a table
T′ with primary key α′, then check the containment
π_{α AS α′}(σ_{ISOF E}_{₁} (ε)) ⊂ π_{α′}(Q _{T̅′}). If the
containment fails, then abort.
      3. Repeat a similar check for E₂. If T has a foreign key of the
form f (E₂·β) → β′ to a table T′ with primary key β′, then check
the containment π_{β AS β′}(σ_{IS OF E}_{₂} (ε)) ⊂ π_{β′}(Q _{T̅′}).
If the containment fails, then abort.
```

Reconstructing Views. In this case, all the previous query views are not changed. However, a query view for the new association set [symbol] is added. Similarly, for the case of update views, the algorithm creates the update view for table T. All other update views are not changed. Algorithm 5 below shows how to create these views.

Algorithm 5: View Computation for AddAssocJT( [symbol] ,E₁,E₂,mult,T,f)

```
1. The query view for association [symbol]   is constructed as follows: [symbol]
      : π_{f(E}_{₁}_{·α) AS E}_{₁}_{·α,f(E}_{₂}_{·β) AS E}_{₂}_{·β}(T) [symbol]
      : [symbol]   (E₁·α, E₂·β).
  2. The update view for table T is constructed as follows:
      Q_{T}: π_{(E}_{₁}_{·α AS f(E}_{₁}_{·α),E}_{₂}_{·β AS f(E}_{₂}_{·β)) pad att(T)} ( [symbol]   )
      τ_{T}: T(att(T)).
3. All other query and update views remain unchanged.
```

Associations Mapped to a Previously Used Table.

For this case, the following primitive may be used to add associations:

AddAssocFK( [symbol] ,E₁,E₂,mult,T,ƒ)

where

1. [symbol] is the name of the new association set.

2. E₁ and E₂ are the endpoints of the association.

3. mult is an expression that denotes the multiplicity of the association. The multiplicity is such that the endpoint corresponding to E₂ is not *.

4. T is a table previously mentioned in mapping fragments, and has update view Q_{T}⁻|τ_{T}⁻.

5. ƒ is a 1-1 function that satisfies the following. Assume that α is the set of primary key attributes of E₁ and β is the set of primary key attributes of E₂. Then ƒ(E₁, α) and ƒ(E₂·β) are sets of attributes in T, and ƒ(E₁·α) is the primary key of T. Moreover, if there is a foreign key from T that mentions the attributes ƒ(E₂·β) then it covers all the attributes ƒ(E₂·β) that is, it is of the form ƒ(E₂·β)→β′.

The semantics of the addition of the new association using the above primitive is given by the following mapping fragment:

π_{E}_{₁}_{·α,E}_{₂}_{·β}( [symbol] )=π_{ƒ(E}_{₁}_{·α),ƒ(E}_{₂}_{·β)}(σ_{ƒ(E}_{₂}_{·β)IS NOT null}(T))

Adapting Mapping Fragments. Let Σ⁻ be the set of mapping fragments before the addition of the new association, and let [symbol] denote the mapping fragment

π_{E}_{₁}_{·α,E}_{₂}_{·β}( [symbol] )=π_{ƒ(E}_{₁}_{·α),ƒ(E}_{₂}_{·β)}(σ_{ƒ(E}_{₂}_{·β)IS NOT null}(T))

In this case, there is no need to adapt the previous set of mapping fragments. A check of the validity of the mapping specified by Σ=Σ⁻∪{ [symbol] } is sufficient. Algorithm 6 performs this validation.

Algorithm 6: Check Validity of Mapping Fragments for
AddAssocFK( [symbol] ,E₁,E₂,mult,T,f):

```
    1. Check that attributes f(E₂·β) in table T have not been previously
used to map data from the client schema by inspecting the mapping
fragments. If any of the attributes are mentioned in a mapping fragment
then abort.
    2. Check that the endpoint of the association corresponding to
entity E₁ can be entirely stored in the primary key of T by
checking the containment π_{α}(σ_{ISOF E}_{₁} (ε)) ⊂ π_{f(E}_{₁}_{·α) AS α}(Q _{T̅}).
If the containment fails, then abort.
    3. If T has a foreign key of the form f(E₂·β) → β′ to a table T₂
with primary key β′, then do the following. Check the containment
π_{β AS β′}(σ_{IS OF E}_{₂} (ε)) ⊂ π_{β′}(Q _{T̅}_{₂}). If the containment fails, then abort.
```

To avoid clashes when the association is mapped to a previously used table, the algorithm ensures that the attribute in T used to store the key of one of the ends of the association has not been previously used in any mapping fragment (Check 1 in Algorithm 6). Moreover, as for the previous case of adding an association, to check the validity of the mapping specified by Σ=Σ⁻∪{ [symbol] }, a check is performed that if T has a foreign key, it is not violated (Check 3). Furthermore, a check is performed that the endpoint of the association corresponding to entity E₁ may be entirely stored in the primary key of T (Check 2).

Reconstructing Views. In this case, all the previous query views are not changed and the algorithm adds the query view for the new association set [symbol] . Similarly, for the case of update views, the algorithm incrementally recomputes the update view for table T; all other update views are not changed. Algorithm 7 shows how to create these views.

Algorithm 7: View Computation for AddAssocFK( [symbol] ,E₁,E₂,mult,T,f)

```
  1. The query view for association [symbol]    is constructed as follows: [symbol]
    : π_{f(E}_{₁}_{·α) AS E}_{₁}_{·α,f(E}_{₂}_{·β) AS E}_{₂}_{β}(σ_{f(E}_{₂}_{·β) IS NOT null}(T)) [symbol]
    : [symbol]    (E₁·α,E₂·β).
  2. The update view for table T is recomputed from the previous
view as follows:
    Q_{T}:
    π_{att(T)\f(E}_{₂}_{·β)}(Q _{T̅}) [symbol]   π_{E}_{₁}_{·α AS f(E}_{₁}_{·α),E}_{₂}_{·β AS f(E}_{₂}_{·β)}( [symbol]   )
    τ_{T}: τ _{T̅}
  3. All other query and update views remain unchanged.
```

An Example of Adding an Association.

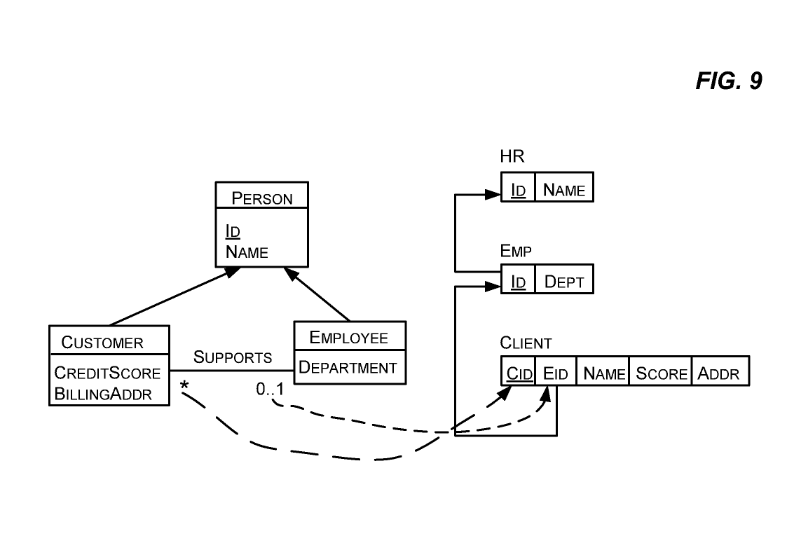

Below, the example mentioned previously is continued to add an association between entity types Customer and Employee. In particular, an association Supports is mapped to the foreign key constraint Client. Eid→Emp. Id, as shown in FIG. 9. For this, the following primitive is used:

AddAssocFK(Supports,Customer,Employee,[*−0 . . . 1],Client,ƒₛᵤₚₚₒᵣₜₛ)

where ƒ_{Supports} is such that ƒ_{Supports}(Customer.Id)=Cid, and ƒ_{Supports} (Employee. Id)=Eid.

In particular, the mapping M₄ specified by the set Σ₄={(φ₁, φ₂, φ₃, φ₄} is considered, where φ₄ is the mapping fragment:

π_{Customer.Id,Employee.Id}(Supports)=π_{Cid,Eid}(σ_{Eid IS NOT null}(Client)).

Algorithm 6 is first used to check whether this new mapping is valid. In Step 1, a check is performed to determine that attribute Eid of table Client is not previously mentioned in the mapping fragment, which is the case (since it is not mentioned in φ₁, φ₂, or φ₃). In Step 2, a check is performed to determine that the identifiers of entities of type Customer may be stored in table Client by checking the containment

π_{Id}(σ_{IS OF Customer}(Persons))⊂π_{Cid AS Id}(Q_{Client}³).

By unfolding the definition of Q_{Customer}³ (and simplifying the expression) the following is obtained:

π_{Id}(σ_{IS OF Customer}(Persons))⊂π_{Cid AS Id}(σ_{IS OF Customer}(Persons)),

which holds. Finally, in Step 3 the foreign key constraint Client. Eid→Emp. Id is checked. The key of entity type Employee is mapped to Eid in table Client, and the foreign key is from table Client to table Emp. In this case, the following containment is tested:

π_{Id}(σ_{IS OF Employee}(Persons))⊂π_{Id}(Q_{Emp}³).

By unfolding the view (and simplifying the expression), the following containment check is obtained:

π_{Id}(σ_{IS OF Employee}(Persons))⊂π_{Id}(σ_{IS OF Employee}(Persons)),

which holds. Because of the above tests, it may be determined that there is a valid mapping fragment.

The query and update views may be computed using Algorithm 7. Step 1 of the algorithm computes the query view for Supports as follows:

Q_{Supports}⁴:π_{Cid AS Customer.Id,Eid AS Employee.Id}(σ_{Eid IS NOT null}(Client))

τ_{Supports}⁴:Supports(Customer.Id,Employee.Id)

For the case of update views, in Step 2 the algorithm recomputes the update view for table Client as follows:

Q_{Client}⁴:π_{Cid,Name,CreditScire,BillingAddr}(Q_{Client}³)

[symbol]

π_{Customer.Id AS Cid,Employee.Id AS Eid}(Supports)

=π_{Id AS Cid,Name,CreditScore AS Score,BillingAddr AS Addr}(σ_{IS OF Customer}(Persons))

[symbol]

π_{Customer.Id AS Cid,Employee.Id AS Eid}(Supports)

τ_{Client}⁴:Client(Cid,Eid,Name,Score,Addr).

The query and update views for all other components remain unchanged.

With the above, a valid mapping has been incrementally constructed that is given by the set of mapping fragments:

π_{Id,Name}(σ_{IS OF(ONLY Person)} [symbol] _{IS OF Employee}(Persons))=π_{Id,Name}(HR)

π_{Id,Department}(σ_{IS OF Employee (Persons)})=π_{Id,Dept}(Emp)

π_{Id,Name,CreditScore,BillingAddr}(σ_{IS OF Customer}(Persons))=π_{Cid,Name,Score,Addr}(Client)

π_{Customer.Id,Employee.Id}(Supports)=π_{Cid,Eid}(σ_{Eid IS NOT null}(Client)).

As an example, the query view for entity type Person that is computed is:

Q_{Person}:(π_{Id,Name}(HR) [symbol] π_{Id,Dept AS Department, t}_{_{Employee}}_{←true}(Emp))\hat{∪}

(π_{Cid AS Id,Name,Score AS CreditScore,Addr AS BillingAddr,t}_{_{Customer}}_{←true}(Client))

τ_{Person}:if (t_{Customer}) then Customer(Id,Name,CreditScore,BillingAddr)

else{if (t_{Employee}) then Employee(Id,Name,Department) else Person(Id,Name))

As an example, the update view for table Client that is computed is:

Q_{Client}:π_{Id AS Cid,Name,CreditScore AS Score,BillingAddr AS Addr (σ}_{ISOF Customer}(Persons)) [symbol] π_{Customer.Id AS Cid,Employee.Id AS Eid}(Supports)

τ_{Client}:Client(Cid,Eid,Name,Score,Addr).

### Adding an Entity: The TPH Case

For a first example, the case is considered in which a new entity type is added to a hierarchy that is completely mapped as TPH. For simplicity of exposition, the entire hierarchy is stored in a single table.

The primitive for adding entities according to the TPH strategy is the following:

AddEntityTPH(E,E′,T,Disc,d_{E},ƒ),

where:
1. E is the new entity type to be added.
2. E′ is the parent of E in the hierarchy (NIL if E is the root of a new hierarchy).
3. T is a table in the store schema storing the full hierarchy to which E′ belongs.
4. Discεatt(T) is an attribute in T that is used to store a discriminator value for entity type E.
5. d_{E} is a value used to identify entity type E (d_{E}εdom(Disc))
6. f: att(E)→(att(T)\{Disc}) is a 1-1 function that maps the primary key of E to the primary key of T. The function ƒ satisfies that for every attribute Aεatt(E) it holds that dom(A)⊂dom(ƒ(A)). Moreover, all the attributes in att(T)\(ƒ(att(E))∪Disc) are nullable.

The semantics of the addition of a new entity by using AddEntityTPH (E, E′, T, Disc, d_{E}, ƒ) is given by the following mapping fragment:

π_{att(E)}(σ_{IS OF(ONLY E)}(ε))=π_{ƒ(att(E))}(σ_{Disc=d}_{_{E}}(T)). (7)

From the above, it can be seen that all the attributes of E are mapped to the same table T.

Adapting the Mapping Fragments.

Assume that a new entity has been added by using AddEntityTPH(E, E′, T, Disc, d_{E}, ƒ), as explained above. Let Σ⁻ be the set of mapping fragments before the addition of the new entity, and let φ_{E} denote the mapping fragment (7). Algorithm 8 shows how to validate and adapt the mapping.

Algorithm 8: Adapt Mapping Fragments for
AddEntityTPH(E,E′,T,Disc,d_{E},f)

```
Let φ_{E} be the mapping fragment
            π_{att(E)}(σ_{IS OF (ONLY E)}(ε)) = π_{f(att(E))}(σ_{Disc=d}_{_{E}}(T)).
0. Check validity of associated foreign keys:
  (a) If T has a foreign key constraint β → β′ to a table T′
with β ∩ f(att(E)) ≠ Ø, then check that the addition
of the new entity does not violate that constraint. This can be done by
checking the query containment π_{β}(Q_{T}) ⊂ π_{β′}(Q_{T′}) using the update
views Q_{T} and Q_{T′} generated below. If the containment fails,
abort; the mapping fragments cannot be adapted.
  (b) Check that d_{E} can be used as valid discriminator value for E
in attribute Disc. In general this check can be done by testing that
π_{Ø}(σ_{Disc=d}_{_{E}}(Q _{T̅})) is unsatisfiable
(always return the empty set).
1. For every mapping fragment ψ in Σ⁻, if the expression IS OF
E′ occurs in ψ, then replace it by IS OF (ONLY E′).
2. Let Σ* be the resulting set of mapping fragments. The new set of
mapping fragments is Σ = Σ* ∪ {φ_{E}}
```

Since the whole hierarchy is mapped as TPH into the same table T, then every ancestor F of E′ is mapped to T by using a condition of the form IS OF (ONLY F). Furthermore, if E′ was a leaf previous to the addition of E, then it may be the case that a condition like IS OF E′ had been used to map E′. In Step 1, this expression is changed by IS OF (ONLY E′) in order to safely add the information of entity type E to table T.

Since d_{E}εdom(Disc) the query in Step 0 Check b is unsatisfiable if and only if Disc has not been previously mapped to any entity attribute A such that d_{E}εdom(A) and the condition Disc=d_{E} has not been previously used in a mapping fragment. This test can be done by inspecting the mapping fragments.

The addition may be generalized by relaxing the assumption that the whole hierarchy is stored in the same table T as TPH. To do this, some changes may be made to the above validation and adaptation strategy. In particular, first, a check may be performed that the primary key constraint in T is not violated by the addition of the new entities. This may be done by checking the containment π_{PK}_{_{T}} _{AS PK}_{_{F}}(Q_{T}⁻)⊂π_{PK}_{_{F}}(σ_{IS OF F}(ε)). Second, a more general form of adaptation may be followed. In Step 1, the strategy for the TPC case may be followed. Furthermore, when constructing update views, they may be recomputed using a strategy similar to TPC.

Incrementally Computing Views.

Algorithm 9 may be used to compute the new query views for the new entity type and incrementally recompute query views for the previous entity types.

Algorithm 9: Reconstruct Query Views

```
1. The query view for E is constructed as follows:
      Q_{E}:π_{f(att(E)) AS att(E)}(σ_{Disc=d}_{_{E}}(T))
      τ_{E}:E(att(E))
2. For every entity type F that is a proper ancestor of E, the query views
are reconstructed as follows:
      Q_{F}:Q _{F̅} \hat{∪} π_{f(att(E)) AS att(E),t}_{_{E}}_{←true}(σ_{Disc=d}_{_{E}}(T))
      τ_{F}:if (t_{E} = true) then τ_{E} else τ _{F̅}
    where t_{E} is a fresh attribute name, not previously mentioned in
    query views.
  3. For all other entity types (not ancestors of E), and for all the
association sets, query views are not changed.
```

Algorithm 10 may be used to incrementally recompute update views.

Algorithm 10: Reconstruct Update Views

```
1. To construct the update view for T, the following may be done.
Construct the query (Q _{T̅})* from Q _{T̅} by replacing every occurrence
of the expression IS OF E′ by IS OF (ONLY E′). Then, Q_{T} may
be computed as:
    Q_{T}:(Q _{T̅})*  \hat{∪}  π_{(att(E) AS f(att(E)),Disc←d}_{_{E}}_{)pad att(T)}(σ_{IS OF (ONLY E)}(ε))
    τ_{T}:T(att(T))
2. For all other tables in the store schema, update views do not change.
```

### Query Rewriting

For an example below, a case is considered in which there is an entity type E₁(Id, A) mapped to a table T₁(Id, A). In this case, the query view for entity type E₁ is Q_{E}_{₁}=π_{Id,A}(T₁). If a new entity type E₂(Id, A, B) is added that inherits from E₁ and is mapped as TPT to a table T₂(Id, B), the query view may be incrementally computed as follows:

Q_{E}_{₁}=π_{Id,A}(T₁) [symbol] π_{Id,B}(T₂).

If a new entity type E₃(Id, A, C) is added that inherits from E₁ and is mapped as TPT to a table T₃(Id, C), then following the process previously described, the query view for E₃ may be obtained by considering the previously computed query for E₁ and table T₃. The process constructs the following query view:

Q_{E}_{₃}=(π_{Id,A}(T₁) [symbol] π_{Id,B}(T₂)) [symbol] π_{Id,C}(T₃).

In this case, the above view may be rewritten into an equivalent query view for entity type E₃ as follows:

Q_{E}_{₃}′=π_{Id,A}(T₁) [symbol] π_{Id,c}(T₃).

In this rewriting, the following implicit constraint is exploited:

π_{Id}(T₂)∩π_{Id}(T₃)=Ø,

which is satisfied by all the store states in the range of the mapping. The constraint is implied because the set of identifiers of entities of type E₂ and E₃ are disjoint.

### Adding a New Entity Type Partitioned Across Several Tables

Below, a case is considered where a new entity type is added using a primitive similar to AddEntity, but in which some client-side conditions are specified to split entities across several tables. The primitive for adding entities that is considered is the following:

AddEntity(E,E′,P,Γ),

where:

1. E is the new entity type to be added.

2. E′ is the parent of E in the hierarchy (NIL if E is the root of a new hierarchy).

3. P is a proper ancestor of E in the hierarchy.

4. F is a set of tuples {(α₁, ψ₁, T₁, ƒ₁), . . . ,(αₙ, ψₙ, Tₙ, ƒₙ)}, where for every iε{1, . . . , n} it holds that:
(a) αᵢ is a subset of the attributes of att(E) that contains the primary key of E
(b) ψᵢ is a satisfiable conjunction of conditions over att(E) and constant values (ψᵢ can be just true), that does not mention the primary key attributes of E. Disjunctions are not considered in ψᵢ.
(c) Tᵢ is a table in the store schema that is not mentioned in any mapping fragment (and such that Tⱼ≠Tᵢ for every j≠i).
(d) ƒᵢ:αᵢ→att(Tᵢ) is a 1-1 function that maps the primary key of E to the primary key of Tᵢ. The function ƒᵢ is such that for every attribute Aεαᵢ it holds that dom(A)⊂dom(ƒᵢ(A)). Moreover, all attributes in att(Tᵢ)\ƒᵢ(αᵢ) are to be nullable.

The semantics of this addition is given by the following set of mapping fragments:

π_{α}_{₁}(σ_{(IS OF E)} [symbol] _{ψ}_{₁}(ε))=π_{ƒ(α}_{ᵢ}₎(T₁) (8)

π_{α}_{ₙ}(σ_{(Is OF E)} [symbol] _{ψ}_{ₙ}(ε))=π_{ƒ(α}_{ₙ}₎(Tₙ)

As for the case of the addition of entity types that were introduced under the TPT/TPC heading above, the reference to the ancestor P is used to specify that all the attributes of E that are not mapped by the above mapping fragments are to be mapped as the attributes in P. If a set Γ is considered with a single tuple of the form (α, true, T, ƒ), the primitive discussed under the TPT/TPC heading is obtained. Nevertheless, in this case the verification process is different. In particular, in the description under the TPT/TPC heading, it was enough to have att(P)∪α=att(E) in order to ensure that entities of type E can be losslessly stored in the store schema. Below, a different condition is checked to test whether the pairs (ψᵢ, αᵢ) cover all the possible entity types of E.

Validation and Adaptation of Mapping Fragments.

To describe what coverage means in this case, some notions are introduced below. Given a conjunction of conditions ψ over some set of attributes and constant values, fix-att(ψ) denotes the set of all attributes A such that there exists a constant value c for which the formula A=c is a logical consequence of ψ. For example, let ψ be the formula

A₁=1 [symbol] A₁=A₂ [symbol] 2≦A₃ [symbol] A₃≦A₄ [symbol] A₄≦2 [symbol] A₅≠3,

where the usual intepretation of inequalilty symbols and natural numbers is assumed.

Then, fix-att(ψ)={A₁, A₂, A₃, A₄} since A₁=1, A₂=1, A₃=2, and A₄=2 are all logical consequences of ψ. If ψ is just a conjunction of equalities between attributes and constant values, then fix-att(ψ) may be obtained efficiently (assuming that ψ is satisfiable). Furthermore, IS null or IS NOT null conditions may be treated as =null or ≠null considering null as a certain constant value. Given a pair (α, ψ), the pair covers attribute A if Aεα∪fix-att(ψ).

Below is described how coverage is to be checked for entities of type E in this case. Given an attribute Aεatt(E)\att(P) that is not part of the primary key of E, a check is performed to determine that the mapping fragments (8) completely cover A by doing the following. Let X_{A}⊂{1, . . . , n} be the set of indexes i such that Aεαᵢ∪fix-att(ψᵢ), that is, iεX_{A} if and only if (αᵢ,ψᵢ) covers A. Then check is performed that the formula

$${⋁}_{i ∈ {X}_{A}} {ψ}_{i} \qquad ( 9 )$$

is a tautology. If that is the case, then the attribute A is covered by the mapping fragments. For example, assume that

Γ={(α₁,ψ₁,ƒ₁,T₁), (α₂,ψ₂,ƒ₂,T₂), (α₃,ψ₃,ƒ₃,T₃)} where α₁={A₂}, α₂={A₁}, α₃={A₁, A₂}, and ψ₁, ψ₂ and ψ₃ are the formulas:

ψ₁:A₁=3 [symbol] A₂≠4

ψ₂:A₁≠3 [symbol] A₂≠4

ψ₃:A₂=4

Then, the attribute A₁ is covered since X_{A}_{₁}={1,2,3} and the formula

(A₁=3 [symbol] A₂≠4) [symbol] (A₁≠3 [symbol] A₂≠4) [symbol] (A₂=4)

is a tautology. On the other hand attribute A₂ is not covered since X_{A}_{₂}={1,3} and the formula

(A₁=3 [symbol] A₂≠4) [symbol] (A₂=4)

is not a tautology (e.g., consider A₁=1 and A₂=3).

Algorithm 11 performs the above-mentioned cover check.

Algorithm 11: Check Coverage for AddEntity(E, E', P, Γ)

```
1. Assume that Γ = {(α₁, ψ₁, f₁, T₁), . . . , (αₙ, ψₙ, fₙ, Tₙ)}, and let χ: = Ø.
2. For every attribute A ∈ att(E)\att(P) that is not a key attribute of E
repeat the following:
    (a) X: = Ø.
    (b) for every i ∈ {1, . . . , n}, if A ∈ αᵢ ∪ fix-att(ψᵢ) then X: = X ∪ {i}.
    (c) if for every Y ∈ χ it holds that Y [symbol]  X then χ: = χ ∪ {X}.
    (d) for every set Y ∈ χ such that X [symbol]  make χ: = χ\{Y}.
3. For every X ∈ χ check whether the formula
${}_{i ∈ X} {ψ}_{i}$
  is a tautology. If some check fails, then return false, else return true.
```

Algorithm 11 follows a slightly different strategy to minimize the number of tautology tests. In Step 2 the algorithm constructs the sets X_{A} for every attribute A and puts them into another set X depending on whether or not there exists a set of indexes in X that is contained in X_{A} (Step 2c). Then (in Step 2d) the algorithm deletes all the sets in X that contain X_{A}. At the end of the iteration of Step 2 the set X only contains the minimal (w·r·t·⊂) sets of indexes for attributes in att(E)\att(P). The reason to keep only those minimal sets is that if A and B are attributes such that X_{A}⊂X_{B}, then if the formula V_{iεX}_{_{A}} ψᵢ is a tautology, then V_{iεX}_{_{B}} ψᵢ is also a tautology.

Algorithm 11 performs a tautology test. Testing if a formula is a tautology is in general a computationally complex process. In practice the tautology test may be done by negating the formula and checking unsatisfiability with a satisfiability problem (SAT) solver.

Algorithm 12 makes the complete adaptation and validation of mappings fragments.

Algorithm 12: Adapt Mapping Fragments for AddEntity(E,E′,P,Γ)

```
Assume that Γ = {(α₁,ψ₁,f₁,T₁),...,(αₙ,ψₙ,fₙ,Tₙ)}, and let
    φ₁: π_{α}_{₁}(σ_{(IS OF E)} [symbol]  ψ_{₁}(ε)) = π_{f(α}_{₁}₎(T₁)
    ...
    φₙ: π_{α}_{ₙ}(σ_{(IS OF E)} [symbol]  ψ_{ₙ}(ε)) = π_{f(α}_{ₙ}₎(Tₙ)
1. Use Algorithm 11 to check coverage of attributes. If the algorithm
fails then abort; the mapping fragments cannot be adapted.
2. Perform the check in Step 0(a) of Algorithm 1. If the check fails
then abort; the mapping fragments cannot be adapted.
3. For every i ∈ {1,...,n} perform the check in Step 0(b) of Algorithm
1 by considering αᵢ, Tᵢ, and fᵢ. If any check fails then abort;
the mapping fragments cannot be adapted.
4. From the set of mapping fragments Σ⁻ construct the set Σ* as in
Step 1 of Algorithm 1.
5. The new set of mapping fragments is the set Σ* ∪ {φ₁,...,φₙ}.
```

Algorithm 12 repeats a process similar to Algorithm 1 for checking foreign key constraints over tables T₁, . . . , Tₙ and for adapting the mapping fragments. In the algorithm, Σ⁻ is the set of mapping fragments before the addition of the new entity type.

The client-side conditions that may be considered can be arbitrary as long as they can be tested for being a tautology. In some cases, conditions may be handled by considering partitions of the domain of every attribute. The partition scheme may not be suitable to handle conditions of the form A=B, where both sides of the equation are column or property references.

Incrementally Computing Views.

To formally describe how to incrementally compute query views, some additional notation is introduced. Given a formula ψ over attributes and constants att(ψ) may denote the set of all attribute names occurring in ψ. Moreover, asgn(ψ) may denote the set of assignments A←c where A=c is a logical consequence of ψ. For example, let ψ be the formula

A₁=1 [symbol] A₁=A₂ [symbol] 2≦A₃ [symbol] A₃≦A₄ [symbol] A₄≦2 [symbol] A₅≠3.

Then, att(ψ)={A₁, A₂, A₃, A₄, A₅} and asgn(ψ)={A₁←1, A₂←1, A₃←2, A₄←2}. Furthermore, the set fix-att(ψ) that was introduced above may be defined as the set of all attributes in att(ψ) that are mentioned in asgn(ψ). If a formula ψ is used when adding a new entity type E, the set of assignments asgn(ψ) may be used to create part of the query view for E. For example, assume that a new entity E is added with attributes K_{E}, A₁, A₂, A₃, A₄ with K_{E} the primary key. Further assume that when adding E the tuple (α, ψ, ƒ, T) is added in Γ such that α is the set of attributes {K_{E}, A₁, A₂, A₃}, ψ is the formula A₁≠1 [symbol] A₃=2 [symbol] A₄=3, and ƒ is a function such that ƒ(K_{E})=K_{T}, ƒ(A₁)=B₁, ƒ(A₂)=B₂, and ƒ(A₃)=B₃. In this case, att(ψ)={A₁, A₃, A₄}, fix-att(ψ)={A₃, A₄}, and asgn(ψ)={A₃←2, A₄←3}. When constructing the query view for E, the following expression may be used

π_{K}_{_{T}} _{AS K}_{_{E}}_{,B}_{₁} _{AS A}_{₁}_{,B}_{₂} _{AS A}_{₂}_{,A}_{₃}_{→2,A}_{₄}_{→3}(T).

That is, for attributes in fix-att(ψ), just the assignments in asgn(ψ) are considered when extracting information from T.

Algorithm 13 shows the complete procedure to create query views in this case.

Algorithm 13: Reconstruct Query Views for AddEntity(E, E′, P, Γ)

```
Assume that Γ = {(α₁, ψ₁, f₁, T₁), . . . , (αₙ, ψₙ, fₙ, Tₙ)}.
1. Let α̅ᵢ̅ be the set of attributes αᵢ\fix-att(ψᵢ), for every i ∈ {1, . . . , n}.
2. The query view for E is constructed as follows. If P = NIL, then
    ${Q}_{E} \text{:} {{n}^{}}_{i = 1} {π}_{f ( \overline{{α}_{i}} ) AS \overline{{α}_{i}} , asgn ( {ψ}_{i} )} ( {T}_{i} )$
      τ_{E}: E(att(E))
  If P ≠ NIL, then the query view for E is:
    ${Q}_{E} \text{:} {Q}_{P}^{-} {{n}^{}}_{i = 1} {π}_{f ( \overline{{α}_{i}} ) AS \overline{{α}_{i}} , asgn ( {ψ}_{i} )} ( {T}_{i} ) )$
      τ_{E}: E(att(E))
3. For every entity type F that is a proper ancestor of E and a proper
descendant of P, the query views are reconstructed as follows. First
consider the query Q_{E}* that is defined as
    ${{n}^{}}_{i = 1} {π}_{f ( \overline{{α}_{i}} ) AS \overline{{α}_{i}} , asgn ( {ψ}_{i} ) , {t}_{E} ← true} ( {T}_{i} )$
  if P = NIL, and as
    ${Q}_{P}^{-} {{n}^{}}_{i = 1} {π}_{f ( \overline{{α}_{i}} ) AS \overline{{α}_{i}} , asgn ( {ψ}_{i} ) , {t}_{E} ← true} ( {T}_{i} ) )$
  if P ≠ NIL, with t_{E} a fresh attribute name, not previously mentioned in
query views. Then the query view for entity type F is:
    Q_{F}: Q_{F}⁻ \hat{∪} Q_{E}*
    τ_{F}: if (t_{E} = true) then τ_{E} else τ_{F}⁻.
4. For every entity type F that is an ancestor of P, the query views are
reconstructed as follows:
    ${Q}_{F} \text{:} {Q}_{F}^{-} { {n}^{}}_{i = 1} {π}_{f ( \overline{{α}_{i}} ) AS \overline{{α}_{i}} , asgn ( {ψ}_{i} ) , {t}_{E} ← true} ( {T}_{i} ) )$
      τ_{F}: if (t_{E} = true) then τ_{E} else τ_{F}⁻
  where t_{E} is a fresh attribute name, not previously mentioned in query
  views.
5. For all other entity types (not ancestors of E), and for all the association
sets, query views are not changed.
```

In considering Algorithm 13, entity E is being split into several pieces and these pieces are being mapped according to mapping fragments (8). Since every mapping fragment maps the primary key attribute of E to a different table, the entity E may be reconstructed by taking the full-outer-join of the information stored in every such table. That is what is done in Step 1 of Algorithm 13. Information on the ancestor P is used to reconstruct the missing information of entities of E. Steps 2 and 3 incrementally recompute the query views for the entity types that are ancestors of E by following a strategy similar to the strategy of Algorithm 2.

Algorithm 14 recomputes update views. It follows a strategy similar to the strategy used for recomputing update views in Algorithm 3.

Algorithm 14: Reconstruct Update Views for AddEntity(E,E′,P,Γ)

```
Assume that Γ = {(α₁,ψ₁,f₁,T₁),...,(αₙ,ψₙ,fₙ,Tₙ)}.
1. For every i ∈ {1,...,n}, the update view for table Tᵢ is
  Q_{T}_{ᵢ}:π_{(α}_{ᵢ} _{AS f(α}_{ᵢ}_{))pad att(T}_{ᵢ}₎(σ_{IS OF E} [symbol]  ψ_{ᵢ}(ε))
  τ_{T}_{ᵢ}:Tᵢ(att(Tᵢ))
2. Perform Step 2 of Algorithm 3.
```

### Adding Entities and Associations Together

In the presence of store-side constraints (e.g., foreign key constraints), different frameworks may impose differing levels of validity checks. For example, assume that an entity type E is mapped to a table T in the store schema and assume that T that has a foreign key to a table T′. For this mapping to be considered valid, one framework may need an association to be mapped to the foreign key relation as well as an entity type mapped to table T′. This requirement may be imposed even in the case that the foreign key attributes in T do not participate in the mapping from entity E. This validity checking is stronger than checking roundtripability, since if the foreign key attributes in T are nullable, then it allows the information of entities of type E to be stored in table T without losing data.

A validity check of a framework may forbid some incremental additions of entity types and associations. For example, a framework may not allow adding an entity type mapped to a table with foreign keys and then adding associations mapped to those foreign keys, since the first addition would result in an invalid mapping.

To deal with this problem, Algorithm 15 is described below that illustrates how an entity and associations may be added to the client schema in a single step. The example considered below is when an entity type E is mapped to a table T that has foreign key constraints γ₁→γ₁′, . . . , γₙ→γₙ′, to tables R₁, . . . , R. In this example, n association sets [symbol] ₁, . . . , [symbol] ₙ mapped to the foreign key constraints are needed. In the example, the case is considered where E is mapped to a single table T.

Consider the following primitives being used together:

$$AddEntity ( E , {E}^{′} , α , P , T , f )$$

$$AddAssocFK ( {1}_{} , E , {E}_{1} , {mult}_{1} , T , {f}_{1} )$$

$$⋮$$

$$AddAssocFK ( {n}_{} , E , {E}_{n} , {mult}_{n} , T , {f}_{n} )$$

where
1. E, E′, α, P and T are as in the AddEntity primitive previously mentioned. T is to be a table that is not previously mentioned in any mapping fragment.
2. ƒ:α→att(T) is a 1-1 function that maps the primary key of E to the primary key of T. The function ƒ is to be such that for every attribute Aεα it holds that dom(A)⊂dom(ƒ(A)).
3. For every iε{1, . . . , n}, [symbol] ᵢ is the name of a new association set with endpoints E and Eᵢ, and multᵢ denotes the multiplicity that cannot be * for the endpoint Eᵢ.
4. For every iε{1, . . . , n}, ƒᵢ is a 1-1 function that satisfies the following. Assume that β is the set of primary key attributes of E and βᵢ is the set of primary key attributes of Eᵢ. Then ƒᵢ(E·β) and ƒᵢ(Eᵢ,βᵢ) are sets of attributes in T and ƒᵢ(E·β) is the primary key of T. Moreover, all attributes in att(T)\(ƒ(E·β)∪ƒ₁(E·β)∪ . . . ∪ƒₙ(E·β)) must be nullable.

The semantics of the addition of the new components using the above primitives is given by the following mapping fragments:

$${π}_{α} ( {σ}_{IS OF E} ( ɛ ) ) = {π}_{f ( α )} ( T )$$

$${π}_{E . β , {E}_{1} . {β}_{1}} ( {1}_{} ) = {π}_{f ( E . β ) , f ( {E}_{1} , {β}_{1} )} ( {σ}_{f ( {E}_{1} . {β}_{1} ) IS NOT null} ( T ) )$$

$$⋮$$

$${π}_{E . β , {E}_{n} \cdot {β}_{n}} ( {n}_{} ) = {π}_{f ( E . β ) , f ( {E}_{n} . {β}_{n} )} ( {σ}_{f ( {E}_{n} . {β}_{n} ) IS NOT null} ( T ) )$$

Algorithm 15 shows how to validate and adapt the mapping fragments.

Algorithm 15: Adapt Mapping Fragments for AddEntity, AddAssocFK

Consider the mapping fragments
${ϕ}_{E} \text{:} {π}_{α} ( {σ}_{IS OF E} ( ɛ ) ) = {π}_{f ( α )} ( T )$ ${ϕ}_{1} \text{:} {π}_{E . β , {E}_{1} . {β}_{1}} ( {1}_{} ) = {π}_{f ( E . β ) , f ( {E}_{1} . {β}_{1} )} ( {σ}_{f ( {E}_{1} . {β}_{1} ) IS NOT null} ( T ) )$ $⋮$ ${ϕ}_{n} \text{:} {π}_{E . β , {E}_{n} . {β}_{n}} ( {n}_{} ) = {π}_{f ( E . β ) , f ( {E}_{n} . {β}_{n} )} ( {σ}_{f ( {E}_{n} . {β}_{n} ) IS NOT null} ( T ) )$
1. Perform Step 0(a) of Algorithm 1 to check validity with respect to
previous associations. If the check fails then abort; the mapping frag-
ments cannot be adapted.
2. Ensure that for every foreign key γ → γ′ in T there is an association set
validly mapped to that foreign key by doing the following. Check that
there exists an index i ∈{1, . . . n) such that fᵢ(Eᵢ.βᵢ) = γ. Now, assume
that the foreign key fᵢ(Eᵢ.βᵢ) → γ′ is to a table T′. Then check the contain-
ment π_{β}_{ᵢ} _{AS γ′} (σ_{IS OF E}_{ᵢ} (ε)) [symbol] π_{γ′}(Q_{T′}), where Q_{T′} is the update view for
table T′ generated by Algorithm 16. If the containment fails, then abort.
3. From the set of mapping fragments Σ⁻ construct the set Σ* as in Step
1 of Algorithm 1.
4. The new set of mapping fragments is the set Σ* ∪ {φ_{E}, φ₁, . . . , φₙ}.

Algorithm 16: View Computation for AddEntity,AddAssocFK

```
1. Query views for entity types are computed by following Steps 1, 2,
and 3 of Algorithm 2.
2. For every association [symbol]   ᵢ with i ∈ {1,...,n} query views are
computed by following Step 1 of Algorithm 7, that is: [symbol]
        : π_{f(E·β) AS E·β,f(E}_{ᵢ}_{·β}_{ᵢ}_{) AS E}_{ᵢ}_{·β}_{ᵢ}(σ_{f(E}_{ᵢ}_{·β}_{ᵢ}_{) IS NOT null}(T)) [symbol]
        : Aᵢ(E·β,Eᵢ·βᵢ).
3. For every table different from T, update views are computed by
following Step 2 of Algorithm 3.
4. For table T the update view is computed as follows. Let α′ be the
set of attributes att(T)\(f₁(E₁·β₁) ∪ ··· ∪ fₙ(Eₙ·βₙ)),
Q_{T}: (··· (π_{(α AS f(α))pad α},(σ_{IS OF E}(ε)) [symbol]
π_{E·β AS f(E·β),E}_{₁}_{·β}_{₁} _{AS f(E}_{₁}_{·β}_{₁}₎( [symbol]   ₁))
          ··· ) [symbol]   π_{E·β AS f(E·β),E}_{ₙ}_{·β}_{ₙ} _{AS f(E}_{ₙ}_{·β}_{ₙ}₎( [symbol]   ₙ)
        τ_{T}: T(att(T))
  5. All other query and update views remain unchanged.
```

Algorithm 15 follows a similar strategy to the strategy followed by Algorithm 1 to check validity with respect to previously added associations and adapting mappings (Steps 1 and 3 of Algorithm 15). In addition, a check is performed to determine whether all the foreign key constraints in T are covered by the new associations and that the associations can be safely mapped to those foreign key constraints (Step 2 of Algorithm 15).

### Refactoring Associations

Below is described mapping adaptation and incremental compilation for the case in which an association between two entity types is replaced by an inheritance relationship between both entity types. Although this change is not an incremental addition to the client schema, it may be treated in a way similar to some of the incremental additions covered so far. First, adding an association (not previously described above) is considered.

Adding Associations with Client Side Referential Constraints.

Below, a procedure is described to address the addition of a class of associations that are manifested in the client schema as explicit client-side referential constraints. These constraints are similar to foreign-key constraints in the store schema and are similarly enforced in the client side. As an example, let E₁ be an entity type with a key given by a single attribute K₁, and E₂ an entity type with a primary key composed of two attributes L₁, L ₂. Consider now an association [symbol] between E₁ and E₂ with multiplicity 1 for E₁ and * for E₂. In one framework, it may be specified that the association [symbol] is given by a referential constraint of the form L₁→K₁. Thus, an entity e₁ of type E₁ is associated with an entity e₂ of type E₂ whenever the value of attribute K₁ of e₁ is equal to the value of attribute L₁ of e₂. This referential association establishes a oneto-many association.

Below, adding the above described type of associations to the client schema is described. Because the association is manifested in the client as a referential constraint, the association may be mapped to an already used table T such that the key of one of the endpoints of the association is mapped to the primary key of T and the key of the other endpoint is mapped to a subset of the primary key attributes of T.

Associations may be added with the following primitive:

AddAssocRC( [symbol] ,E₁,E₂,mult,T,ƒ)

where:

1. E₁ and E₂ are the endpoints of the association set [symbol] .

2. [symbol] is manifested as a referential constraint in the client-side of the form β→α where α is the set of key attributes of E₁ and β is a subset of the key attributes of E₂.

3. mult is an expression that denotes the multiplicity of the association. The multiplicity is such that the endpoint corresponding to E₁ is 1. Depending on the referential constraint the multiplicity of E₂ is to be:
1 or 0.1 if β is the complete key of E₂, and
* if β is a proper subset of the key attributes of E₂.

4. T is a table previously mentioned in mapping fragments and has update view Q_{T}⁻|τ_{T}⁻.

5. ƒ is a 1-1 function that satisfies the following. Assume that γ is the set of primary key attributes of E₂. Then ƒ(E₂·γ) is the primary key of T. Moreover, if there is a foreign key from T that mentions the attributes ƒ(E₂·β) then it covers all the attributes ƒ(E₂·β) that is, it is of the form ƒ(E₂·β)→β′.

The semantics of the addition of the new association using the above primitive is given by the following mapping fragment:

π_{E}_{₁}_{·α,E}_{₂}_{·γ}( [symbol] )=π_{ƒ(E}_{₂}_{·β),ƒ(E}_{₂}_{·γ)}(T) (10)

The primary key α of E₁ is mapped to the set of attributes ƒ(E₂·β) in table T which are part of the primary key of T. If the primary key α of E₁ is mapped to a different set of attributes not previously used in table T, the methodology previously described (e.g., under the title Associations Mapped to a Previously Used Table) above may be used to add the association to the client schema.

When a case is covered by the methodology previously described, there may be no need to adapt the previous mapping fragment. Instead, a check may be performed of the validity of the new mapping given by the previous set of mapping fragments plus the mapping fragment (10). Algorithm 17 performs this validation.

Algorithm 17: Check Validity of Mapping Fragments for
AddAssocRC( [symbol] ,E₁,E₂,mult,T,f)

1. Check that the endpoint of the association corresponding to entity E₂
can be entirely stored in the primary key of T by checking the containment
π_{γ}(σ_{IS OF E}_{₂}(ε)) ⊂ π_{f(E}_{₂}_{·γ) AS γ}(Q _{T̅}). If the containment fails, then abort.
2. If T has a foreign key of the form f (E₂·β) → β′ to a table
T₂ with primary key β′, then do the following. Check the containment
π_{β AS β′}(σ_{IS OF E}_{₂}(ε)) ⊂ π_{β},(Q _{T̅}_{₂}).
While checking this containment, consider the referential constraint
E₂·β → E₁·α. If the containment fails, then abort

As described previously, in this case, all the previous query views are not changed and there is only a need to add the query view for the new association set [symbol] . Algorithm 18 shows how to create this view.

Algorithm 18: View Computation for AddAssocRC( [symbol] ,E₁,E₂,mult,T,f)

```
1. The query view for association [symbol]   is constructed as follows: [symbol]
      : π_{f(E}_{₂}_{·β) AS E}_{₁}_{·α,f(E}_{₂}_{·γ) AS E}_{₂}_{·γ}(T) [symbol]
      : [symbol]   (E₁·α,E₂·β).
2. All other query and update views remain unchanged.
```

For the case of update views there is no need to make any changes since the new association is stored in table T just by using the information of the primary key of entities of type E₂ (that was already mapped to table T) materialized in the store side in the primary key of table T.

Replacing Association by Inheritance.

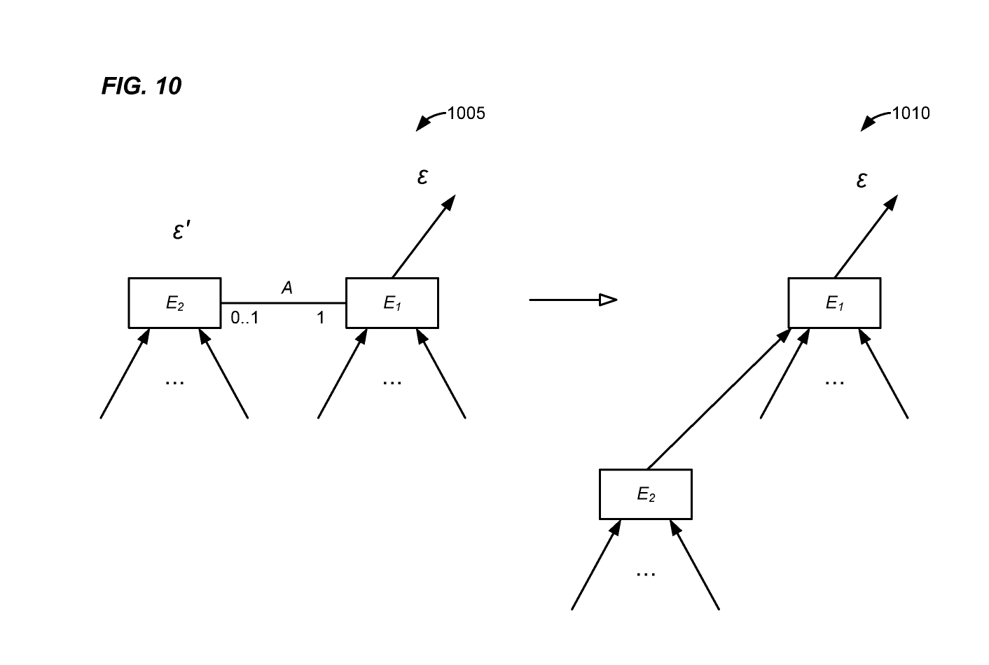

A diagram of the general case described below is shown in FIG. 10. Turning to FIG. 10, the goal is to go from the schema 1005 on the left where there are entity types E₁ and E₂ and an association A between them, to the schema 1010 in the right in which E₂ is a subtype of E₁. Although entity type E₂ has the same name in both sides of FIG. 10, type E₂ actually changes. In the schema 1010 at the right of the FIG. 10 entity type E₂ is to also contain the attributes of entity type E₁. This same change happens with all the entity types that derive from E₂. The process is sometimes referred to herein as refactoring.

To formalize the process, assume that initially entity type E₁ is part of an entity set E, entity type E₂ is part of an entity set ε′ and that E₂ is the root of the hierarchy of types to which it belongs (as shown in FIG. 10). To avoid confusion, for every type E that is a descendant of E₂ (including E₂) att⁻(E) is used to denote the set of attributes of E before the refactoring, and att⁺(E) is used to denote the set of attributes after the refactoring. Since after the refactoring E₂ is a descendant of E₁, for every descendant E of E₂, it holds that att⁺(E)=att⁻(E)∪att(E₁). For simplicity in exposition, an assumption may be made that the name of the key attributes of E₁ and of E₂ are the same. If that is not the case, the refactoring process also considers renaming the key attributes of E₂ and its derived types.

For the refactoring process, the following primitive is considered:

Refact(E₁,E₂, [symbol] )

where:

1. [symbol] is an association between E₁ and E₂ given by a referential constraint in the client side from the key attributes of E₂ to the key attributes of E₁.

2. The multiplicity of E₁ in the association is 1 and the multiplicity of E₂ is 0 . . . 1.

3. E₂ is the root of a hierarchy of entity types.

The application of Refact(E₁, E₂, [symbol] ) has the same effect shown in FIG. 10 over the client schema. That is, after Refact(E₁, E₂, [symbol] ), E₂ is a child of E₁ and the entire hierarchy is part of the entity set ε (i.e., entity set ε′ is no longer part of the client schema).

Algorithm 19 shows the adaptation of the mapping fragments after Refact(E₁, E₂, [symbol] ).

Algorithm 19: Adapt Mapping Fragments for Refact(E₁,E₂, [symbol] )

```
1 . For every mapping fragment ψ in Σ⁻ do the following:
  (a) Replace every occurrence of association set [symbol]   in ψ by
the expression σ_{IS OF E}_{₂} (ε) and treat both endpoints of
association set A in ψ as the key attributes of entity type E₂.
  (b) Replace every occurrence of entity set ε′ in ψ by entity set ε.
  (c) Replace every occurrence of an expression IS OF (ONLY E₁)
in ψ, by the expression
                IS OF (ONLY E₁) [symbol]   IS OF E₂
2.  Let Σ* be the resulting set, then Σ* is the set of mapping
fragments after the refactoring.
```

In Algorithm 19, Σ⁻ denotes the set of mapping fragments before the refactoring. For point 1(a) of Algorithm 19, assume, for explanation sake, that before the refactoring the set of mappings contains a mapping fragment of the form

π_{E}_{₁}_{·α,E}_{₂}_{·α}( [symbol] )=π_{β,γ}(T), (11)

where α is the set of key attributes of E₁ and E₂, and T is an arbitrary table in the store. After the refactoring, the association set [symbol] is no longer part of the client schema. In Step 1(a), Algorithm 19 deals with deletion of [symbol] replacing the mapping mapping fragment (11) by:

π_{E}_{₂}_{·α,E}_{₂}_{·α}(σ_{ISOF E}_{₂}(ε))=π_{β,γ}(T).

Above, the reference to [symbol] has been replaced by a single reference to entity type E₂, and both endpoints of [symbol] have been replaced by references to the key attributes of E₂. Similarly, since after the refactoring entity set ε′ is no longer part of the client schema, in Step 1(b), Algorithm 19 replaces any reference to ε′ by ε.

The adaptation does not need any additional validation. Since the mapping was valid before the refactoring, it can be proved that the form of adapting the mapping fragments described above gives a valid mapping.

Algorithm 20 shows how query views may be recomputed. For an entity type E, Q_{E}⁻|τ_{E}⁻ denotes the query view for E before the refactoring.

Algorithm 20: Reconstruct Query Views for Refact(E₁,E₂, [symbol] )

```
1. For every entity type E that is a descendant of E₂, the query views are
reconstructed as follows:
  (a) First, the expression τ_{E} from τ_{Ē} is reconstructed. For every
entity type F that is a descendant of E, if τ_{Ē} contains an expression of
the form F(att⁻(F)), then replace it by F(att⁺(F)).
  (b) For the relational part of the query view for E, consider the
following expression
      Q_{E}: Q_{Ē} [symbol]   Q_{Ē}_{₁}.
2. For every entity type E that is an ancestor of E₁ the query view is:
      Q_{E}: Q_{Ē} [symbol]   (Q_{Ē}_{₂} × {t_{E}_{₂} ← true})
      τ_{E}: if (t_{E}_{₂} = true) then τ_{E}_{₂} else τ_{Ē}.
    where t_{E}_{₂} is a fresh attribute name, not previously mentioned in
    query views.
3. For all other entity types and for all the association sets, query views
are not changed.
```

For recomputing update views a strategy similar to the strategy for adapting mapping fragments is followed. The details of the strategy are described in Algorithm 21.

Algorithm 21: Reconstruct Update Views for Refact(E₁,E₂, [symbol] )

```
1. For every update view Q _{R̅} construct Q_{R} from Q _{R̅} as follows:
      (a) Replace every occurrence of association set [symbol]   in Q_{R} by the
expression σ_{IS OF E}_{₂} (ε) and treat both endpoints of association set
A in Q_{R} as the key attributes of entity type E₂.
      (b) Replace every occurrence of entity set ε′ in Q _{R̅} by entity set ε.
      (c) Replace every occurrence of an expression IS OF (ONLY E₁)
in Q _{R̅}, by the expression
                        IS OF (ONLY E₁) [symbol]   IS OF E₂.
```

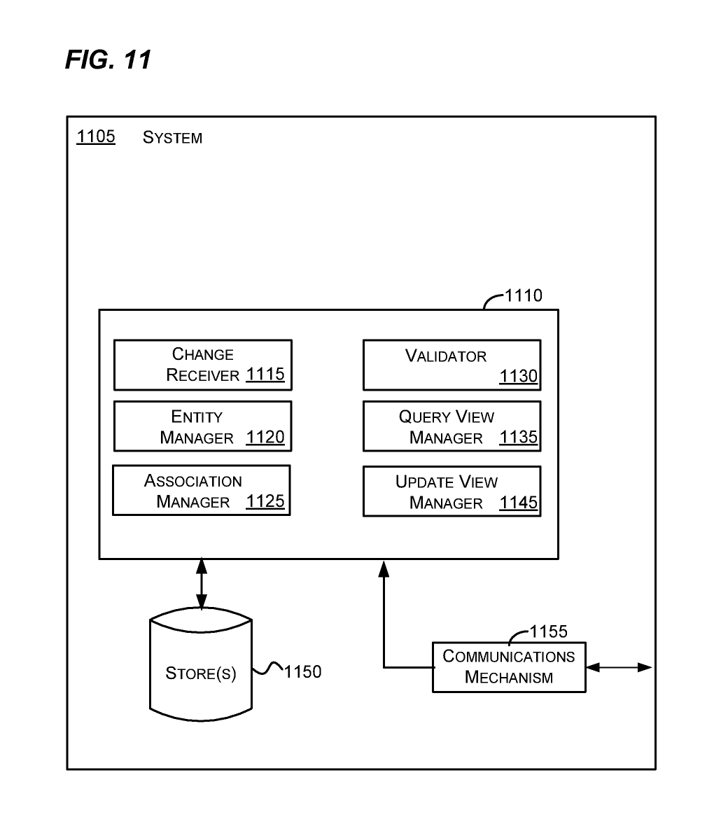

FIG. 11 is a block diagram representing an exemplary arrangement of components of a system in which aspects of the subject matter described herein may operate. The components illustrated in FIG. 11 are exemplary and are not meant to be all-inclusive of components that may be needed or included. In other embodiments, the components and/or functions described in conjunction with FIG. 5 may be included in other components (shown or not shown) or placed in subcomponents without departing from the spirit or scope of aspects of the subject matter described herein. In some embodiments, the components and/or functions described in conjunction with FIG. 11 may be distributed across multiple devices.

Turning to FIG. 11, the system 1105 may include incremental components 1110, store(s) 1150, a communications mechanism 1155, and other components (not shown). The system 1105 may comprise one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like.

Where the system 1105 comprises a single device, an exemplary device that may be configured to act as the system 1105 comprises the computer 110 of FIG. 1. Where the system 1105 comprises multiple devices, each of the multiple devices may comprise a similarly or differently configured computer 110 of FIG. 1.

The incremental components 1110 may include a change receiver 1115, an entity manager 1120, an association manager 1125, a validator 1130, a query view manager 1135, an update view manager 1145, and other components (not shown). As used herein, the term component is to be read to include hardware such as all or a portion of a device, a collection of one or more software modules or portions thereof, some combination of one or more software modules or portions thereof and one or more devices or portions thereof, and the like.

The communications mechanism 1155 allows the system 1105 to communicate with other entities. For example, the communications mechanism 1155 may allow the system 1105 to communicate with applications or database management systems (DBMSs) on remote hosts. The communications mechanism 1155 may be a network interface or adapter 170, modem 172, or any other mechanism for establishing communications as described in conjunction with FIG. 1.

The store(s) 1150 include any storage media capable of providing access to data. The term data is to be read broadly to include anything that may be represented by one or more computer storage elements. Logically, data may be represented as a series of 1's and 0's in volatile or non-volatile memory. In computers that have a non-binary storage medium, data may be represented according to the capabilities of the storage medium. Data may be organized into different types of data structures including simple data types such as numbers, letters, and the like, hierarchical, linked, or other related data types, data structures that include multiple other data structures or simple data types, and the like. Some examples of data include information, program code, program state, program data, other data, and the like.

The store(s) 1150 may comprise hard disk storage, other non-volatile storage, volatile memory such as RAM, other storage, some combination of the above, and the like and may be distributed across multiple devices. The store(s) 1150 may be external, internal, or include components that are both internal and external to the system 1105.

The store(s) 1150 may host databases and may be accessed via conesponding DBMSs. Access as used herein may include reading data, writing data, deleting data, updating data, a combination including two or more of the above, and the like.

The change receiver 1115 is operable to receive an indication of a change to a client schema (e.g., via message passing, being called, or otherwise) and to receive a compilation directive (e.g., TPT, TPC, TPH, partition, or the like) associated with the change. The client schema is mapped to a store schema via mapping data specified by a set Σ of mapping fragments.

The entity manager 1120 is operable to use the compilation directive in incrementally modifying the store schema in response to the change to the client schema. The entity manager 1120 may select one or more of the algorithms described herein to perform the incremental modification. The entity manager 1120 may use the compilation directive to select the algorithm(s). For example, for a TPT or TPC directive, the entity manager 1120 may select Algorithm 1.

The association manager 1125 is operable to use the compilation directive in incrementally modifying the mapping data in response to the change to the client schema. The association manager 1125 may operate similarly to the entity manager 1120 in selecting the algorithm. For example, for a TPT or TPC directive, the association manager 1125 may select Algorithm 1. In one embodiment, the association manager 1125 and the entity manager 1120 may be combined into one component or may share an algorithm selection function.

The validator 1130 is operable to validate that modifications to the store schema and the mapping data do not violate constraints placed on the store schema. The validator may use as a starting point (e.g., an assumption) that the store schema was valid (e.g., did not violate any constraints) prior to the modifications and may perform an incremental validation (also referred to as a local validation) that is effective for the modifications instead of re-validating the entire store schema. The validator may use appropriate algorithms described herein to validate the store schema.

The query view manager 1135 may update query views as described by algorithms herein. Likewise, the update view manager 1145 may modify update views as described herein.

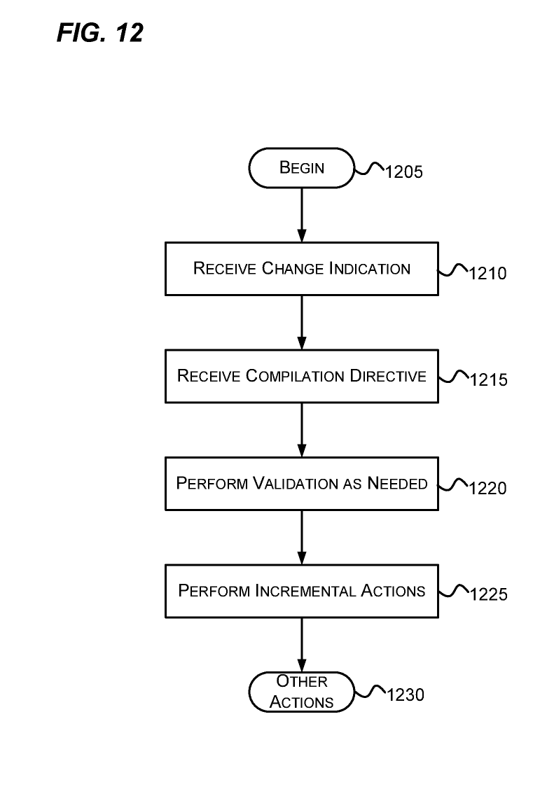

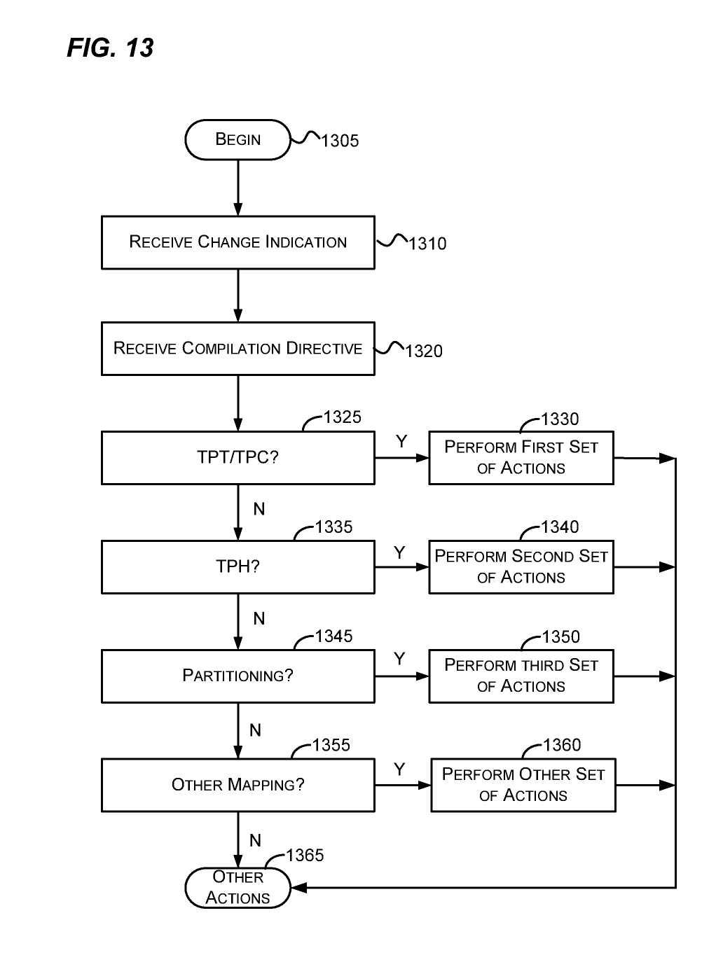

FIGS. 12-13 are flow diagrams that generally represent exemplary actions that may occur in accordance with aspects of the subject matter described herein. For simplicity of explanation, the methodology described in conjunction with FIGS. 12-13 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 12, at block 1205, the actions begin. At block 1210, an indication is received of a change to a client schema. For example, referring to FIGS. 7 and 11, the change receiver 1115 receives an indication that a new Employee entity type has been added to a client schema. As another example, the change receiver 1115 may receive an indication that a relationship has been added to the client schema.

At block 1215, a compilation directive associated with the change is received. The compilation directive may be received together with the indication of the change or in a separate communication. The compilation directive may indicate how one or more types in the client schema are mapped to one or more types in the store schema. As mentioned previously, these mapping strategies may include one or more of: table-per-type, table-per-concrete-type, table-per-hierarchy, and partitioned across tables. For example, referring to FIGS. 7 and 11, the change receiver 1115 receives an indication that the new Employee entity type is to be mapped as TPT.

At block 1220, validation is performed as needed. As mentioned previously, this validation may forego re-validating the entire store schema and may focus on local validations that validate only a portion of the mapping data where the portion is affected by the change. For example, referring to FIG. 11, a check is performed to determine that the foreign key constraint Emp. Id→HR. Id is not violated.

At block 1225, incremental actions are performed. Incremental actions may include incrementally modifying the mapping data and storage schema to be consistent with the requested change. For example, if the incremental action is to add entity type, then the storage schema may be modified to add a table to store the entity type, and the mapping data may be modified to include mapping fragments that express the mapping from the added entity type to the added table. Incrementally modifying the mapping data and storage schema may involve creating new entities and/or relationships, deleting existing entities and/or relationships, updating existing entities and/or relationships, adding mapping fragments, incrementally modifying query and/or update views, and the like. For example, referring to FIG. 11, the entity manager 1120 and the association manager 1125 may update/create/delete entities and relationships on the store schema and the query view manager 1135 and the update view manager 1145 may update/create/delete query views and update views.

Incrementally modifying the mapping data and storage schema to be consistent with the requested change may include incrementally modifying only a subset of the mapping data and storage schema, where the subset including only a minimal portion of the mapping data and storage schema

At block 1230, other actions, if any, may be performed.

Turning to FIG. 13, at block 1305, the actions begin. At block 1310, an indication is received that a new type has been added to a client schema. The client schema is mapped to a store schema via mapping data. For example, referring to FIGS. 7 and 11, the change receiver 1115 receives an indication that a new Employee entity type has been added to a client schema. As another example, the change receiver 1115 may receive an indication that a relationship has been added to the client schema.

At block 1320, a compilation directive associated with the change is received. The compilation directive may be received together with the indication of the change or in a separate communication. The compilation directive may indicate how one or more types in the client schema are mapped to one or more types in the store schema. For example, referring to FIGS. 7 and 11, the change receiver 1115 receives an indication that the new Employee entity type is to be mapped as TPT.

At block 1325, if the compilation directive indicates mapping TPT or TPC, the actions continue at block 1330; otherwise, the actions continue at block 1335. At block 1330, a first set of actions is performed to incrementally modify the mapping data. For example, referring to FIG. 7, the new entity type Employee is mapped to the table Emp. In addition, the first set of actions may include such things as:

1. checking whether referential constraints expressed as tests for query containment and associated with modifying the mapping for the new type are valid;

2. if the referential constraints are not valid, aborting modifying the mapping data; and

3. if the referential constraints are valid, then modifying the mapping data for each proper ancestor and for each proper descendant of the new type.

The first set of actions may also include other actions specified by algorithms described herein.

At block 1335, if the compilation directive indicates mapping TPH, the actions continue at block 1340; otherwise, the actions continue at block 1345. At block 1340, a second set of actions is performed to incrementally modify the mapping data. For example, actions under the heading “Adding an Entity: the TPH case” may be performed. These actions may include, for example:

1. checking whether keys associated with modifying mapping for the new type are valid;

2. if the keys are not valid, aborting modifying the mapping data;

3. if the keys are valid, identifying a parent type of the new type and modifying the mapping data only for the parent type.

At block 1345, if the compilation directive indicates partitioning the new type across a plurality of tables, the actions continue at block 1350; otherwise, the actions continue at block 1355. At block 1350, a third set of actions is performed to incrementally modify the mapping data. For example, the actions under the heading “Adding a New Entity Type Partitioned across Several Tables” may be performed. These actions may include, for example:

1. checking coverage of attributes for the new type;

2. if the coverage fails, aborting modifying the mapping data;

3. if the coverage succeeds, checking whether keys associated with modifying mapping for the new type are valid;

4. if the keys are not valid, aborting modifying the mapping data; and

5. if the keys are valid, then modifying the mapping data for each proper ancestor and for each proper descendant of the new type.

In some implementations there may be other ways of mapping entities and mappings in the client schema to the store schema. At block 1355, if the mapping directive indicates a different mapping, the actions continue at block 1360; otherwise, the actions continue at block 1365. At block 1360, actions appropriate for the mapping directive are performed.

At block 1365, other actions, if any, are performed. These other actions may include, for example:

1. receiving an indication that a new association has been added to the client schema and in response checking validity of mapping fragments for the new association. If the mapping fragments for the new association are invalid, then aborting the mapping data;

2. modifying the mapping data to account for the new type in conjunction with modifying the mapping data to account for the new association;

3. incrementally updating an update view based on the new type;

4. incrementally updating a query view based on the new type;

5. other actions indicated by algorithms and elsewhere herein.

As can be seen from the foregoing detailed description, aspects have been described related to incrementally modifying schemas and mappings. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving an indication of a change to a client schema, the client schema having types that are mapped via mapping data to corresponding types of a store schema;
receiving a compilation directive associated with the change;
based on the change and the compilation directive, incrementally modifying the mapping data and storage schema to be consistent with the change; and
performing a local validation that validates only a portion of the mapping data, the portion of the mapping data associated with the change.

2. The method of claim 1, wherein receiving an indication of a change to a client schema comprises receiving an indication that a type has been added to the client schema.

3. The method of claim 1, wherein receiving an indication of a change to a client schema comprises receiving an indication that a relationship has been added to the client schema.

4. The method of claim 1, wherein receiving a compilation directive associated with the change comprises receiving data that indicates how types in the client schema are mapped to types in the store schema.

5. The method of claim 4, wherein receiving data that indicates how types in the client schema are mapped to types in the store schema comprises receiving data that includes one or more of table-per-type, table-per-concrete-type, table-per-hierarchy, and partitioned across tables.

6. The method of claim 1, wherein incrementally modifying the mapping data and storage schema to be consistent with the change comprises incrementally modifying only a subset of the mapping data and storage schema, the subset including only a minimal portion of the mapping data and storage schema required to be changed to be consistent with the change.

7. The method of claim 1, wherein performing a local validation comprises verifying that mapping data within the portion roundtrips.

8. The method of claim 1, wherein incrementally modifying the mapping data and storage schema comprises incrementally modifying query and update views.

9. A computer storage medium having computer-executable instructions, which when executed perform actions, comprising:
receiving an indication that a new type has been added to a client schema, the client schema mapped to a store schema via mapping data;
receiving a compilation directive associated with the new type, the compilation directive indicating a mapping strategy to use in mapping the new type to the store schema;
if the compilation directive indicates mapping table-per-type or table-per-concrete type, performing a first set of actions to incrementally modify the mapping data;
if the compilation directive indicates mapping table-per-hierarchy, performing a second set of actions to incrementally modify the mapping data; and
if the compilation directive indicates partitioning the new type across a plurality of tables, performing a third set of actions to incrementally modify the mapping data.

10. The computer storage medium of claim 9, wherein performing a first set of actions to attempt to incrementally modify the mapping data comprises:
checking whether referential constraints expressed as tests for query containment and associated with modifying the mapping for the new type are valid;
if the referential constraints are not valid, aborting modifying the mapping data;
if the referential constraints are valid, then modifying the mapping data for each proper ancestor.

11. The computer storage medium of claim 9, wherein performing a second set of actions to incrementally modify the mapping data comprises:
checking whether keys associated with modifying the mapping for the new type are valid;
if the keys are not valid, aborting modifying the mapping data;
if the keys are valid, identifying a parent type of the new type and modifying the mapping data only for the parent type.

12. The computer storage medium of claim 9, wherein performing the third set of actions to incrementally modify the mapping data comprises:
checking coverage of attributes for the new type;
if the coverage fails, aborting modifying the mapping data;
if the coverage succeeds, checking whether keys associated with modifying mapping for the new type are valid;
if the keys are not valid, aborting modifying the mapping data; and
if the keys are valid, then modifying the mapping data for each proper ancestor and for each proper descendant of the new type.

13. The computer storage medium of claim 9, further comprising receiving an indication that a new association has been added to the client schema, and in response, checking validity of mapping fragments for the new association.

14. The computer storage medium of claim 13, further comprising if the mapping fragments for the new association are invalid, then aborting modifying the mapping data.

15. The computer storage medium of claim 13, further comprising modifying the mapping data to account for the new type in conjunction with modifying the mapping data to account for the new association.

16. The computer storage medium of claim 9, further comprising incrementally validating the mapping data.

17. The computer storage medium of claim 9, further comprising incrementally updating an update view based on the new type.

18. The computer storage medium of claim 9, further comprising incrementally updating a query view based on the new type.

19. In a computing environment, a system, comprising:
a change receiver operable to receive an indication of a change to a client schema and to receive a compilation directive associated with the change, the client schema being mapped to a store schema via mapping data;
an entity manager operable to use the compilation directive in incrementally modifying the store schema in response to the change to the client schema;
an association manager operable to use the compilation directive in incrementally modifying the mapping data in response to the change to the client schema; and
a validator operable to validate that modifications to the store schema and the mapping data do not violate constraints placed on the store schema, the validator using as a starting point that the store schema was valid prior to the modifications.

20. The system of claim 19, further comprising:
a query view manager operable to incrementally update a query view in response to the change; and
an update view manager operable to incrementally update an update view in response to the change.
